(19) United States
(12) Patent Application Publication
(10) Pub. No.: US 2023/0169118 A1
(43) Pub. Date: Jun. 1, 2023

(54) INFORMATION PRESENTING METHOD, RECORDING MEDIUM, INFORMATION PRESENTING SYSTEM, AND TERMINAL DEVICE

(71) Applicant: Panasonic Intellectual Property Management Co., Ltd., Osaka (JP)

(72) Inventors: Mitsuhiro ASO, Shiga (JP); Michiko SASAGAWA, Osaka (JP); Naohisa TANABE, Osaka (JP); Nobue NARITA, Osaka (JP)

(21) Appl. No.: 17/792,331

(22) PCT Filed: Aug. 26, 2021
(86) PCT No.: PCT/JP2021/031334

§ 371 Date: Jul. 12, 2022

(30) Foreign Application Priority Data
Feb. 25, 2021 (JP) 2021-029309

(51) Int. Cl. G06F 16/9032; G06F 16/904; G06F 3/16

(52) U.S. Cl. CPC G06F 16/9032; G06F 16/904; G06F 3/167; G06F 3/0484

(57) ABSTRACT

An information presenting method includes an obtaining step, a meal recommendation determining step, a presenting step, and a rating accepting step. In the obtaining step, user information pertaining to a user is obtained. In the meal recommendation determining step, based on the user information obtained in the obtaining step, a meal recommendation corresponding to a priority status determined to have a high priority level for the user is determined from among a plurality of statuses related to the user. In the presenting step, the meal recommendation determined in the meal recommendation determining step is presented to the user. In the rating accepting step, a rating by the user of the meal recommendation presented in the presenting step is accepted. The rating indicates whether the user cooked a food in the meal recommendation or whether the user ate the food.

### CROSS-REFERENCE OF RELATED APPLICATIONS

This application is the U.S. National Phase under 35 U.S.C. § 371 of International Patent Application No. PCT/JP2021/031334, filed on Aug. 26, 2021, which in turn claims the benefit of Japanese Patent Application No. 2021-029309, filed on Feb. 25, 2021, the entire disclosures of which applications are incorporated by reference herein.

### TECHNICAL FIELD

The present disclosure generally relates to an information presenting method, a recording medium, an information presenting system, and a terminal device. The present disclosure more particularly relates to an information presenting method, a recording medium, an information presenting system, and a terminal device that present, to a user, one piece of presentation information from among a plurality of pieces of presentation information.

### BACKGROUND ART

PTL 1 discloses a music search system. This music search system manages music data in association with 5W1H information, and makes it possible to search for music matching user preferences, situations, and the like based on 5W1H search keywords. In the music search system, an information terminal includes a search requester that accepts the input of 5W1H information from a user and makes a request to search for a music piece, a music player that plays back the music piece, and a library registrar that registers a desired music piece in a library.

### CITATION LIST

### Patent Literature

[PTL 1] International Publication No. 2017/033220

### SUMMARY OF INVENTION

### Technical Problem

The music search system disclosed in PTL 1 requires users to input 5W1H information into the search requester by themselves in order to obtain music search results.

Having been conceived in light of the foregoing circumstances, an object of the present disclosure is to provide an information presenting method, a recording medium, an information presenting system, and a terminal device which easily reflects a user's intentions while improving convenience for the user.

### Solution to Problem

An information presenting method according to one aspect of the present disclosure includes an obtaining step, a meal recommendation determining step, a presenting step, and a rating accepting step. In the obtaining step, user information pertaining to a user is obtained. In the meal recommendation determining step, a meal recommendation corresponding to a priority status determined to have a high priority level for the user from among a plurality of statuses related to the user is determined based on the user information obtained in the obtaining step. In the presenting step, the meal recommendation determined in the meal recommendation determining step is presented to the user. In the rating accepting step, a rating made by the user for the meal recommendation presented in the presenting step is accepted. The rating indicates whether the user cooked a food in the meal recommendation or whether the user ate the food.

A recording medium according to one aspect of the present disclosure is a non-transitory computer-readable recording medium having recorded thereon a program that causes at least one processor to execute the foregoing information presenting method.

An information presenting system according to one aspect of the present disclosure includes an obtainer, a meal recommendation determiner, a presenter, and a rating acceptor. The obtainer obtains user information pertaining to a user. The meal recommendation determiner determines, based on the user information obtained by the obtainer, a meal recommendation corresponding to a priority status determined to have a high priority level for the user from among a plurality of statuses related to the user. The presenter presents, to the user, the meal recommendation determined by the meal recommendation determiner. The rating acceptor accepts a rating made by the user for the meal recommendation presented by the presenter. The rating indicates whether the user cooked a food in the meal recommendation or whether the user ate the food.

A terminal device according to one aspect of the present disclosure includes a communicator and an outputter. The communicator communicates with the foregoing information presenting system. When a signal including the meal recommendation is received from the presenter by the communicator, the outputter causes the meal recommendation to be displayed in a display.

### Advantageous Effects of Invention

The present disclosure provides an advantage in that it is easy to reflect a user's intentions while improving convenience for the user.

### BRIEF DESCRIPTION OF DRAWINGS

FIG. 1 is a diagram illustrating the overall configuration of an information presenting system according to a reference example.

FIG. 2 is a block diagram of a terminal device in the stated information presenting system.

FIG. 3A is a conceptual diagram illustrating a group including a plurality of users in the stated information presenting system.

FIG. 3B is a conceptual diagram illustrating condition information in the stated information presenting system.

FIG. 3C is a conceptual diagram illustrating attributes in the stated information presenting system.

FIG. 4 is a diagram illustrating screen transitions in the stated terminal device.

FIG. 5 is a sequence chart illustrating an example of operations in the stated information presenting system.

FIG. 6 is a diagram illustrating a variation on the stated terminal device.

FIG. 7 is a diagram illustrating another variation on the stated terminal device.

FIG. 8 is a block diagram illustrating the functional configuration of a presenting system according to a specific example of the reference example.

FIG. 9 is a flowchart illustrating operations of the information presenting system according to a specific example of the reference example.

FIG. 10 is a diagram illustrating an example of deleting an intermediate word according to a specific example of the reference example.

FIG. 11 is a diagram illustrating an example of a hidden item list according to a specific example of the reference example.

FIG. 12 is a flowchart illustrating operations pertaining to the deletion of an intermediate word according to a specific example of the reference example.

FIG. 13 is a diagram illustrating an example of updating an intermediate word according to a specific example of the reference example.

FIG. 14 is a flowchart illustrating operations pertaining to the updating of an intermediate word according to a specific example of the reference example.

FIG. 15 is a diagram illustrating an example of intermediate words presented in a manner dependent on the value of ingredients according to a specific example of the reference example.

FIG. 16 is a diagram illustrating an example of intermediate words presented based on user information according to a specific example of the reference example.

FIG. 17 is a diagram illustrating the overall configuration of an information presenting system and a terminal device according to an embodiment.

FIG. 18 is a diagram illustrating an example of a meal recommendation and intermediate words displayed in the terminal device according to the embodiment.

FIG. 19 is a diagram illustrating an example of a rating of a meal recommendation by a user in the terminal device according to the embodiment.

FIG. 20 is a flowchart illustrating an example of operations of the information presenting system according to the embodiment.

FIG. 21 is a flowchart illustrating another example of operations of the information presenting system according to the embodiment.

### DESCRIPTION OF EMBODIMENTS

### Reference Example

### (1) Overview

The drawings described in the following reference example are schematic drawings, and the size and thickness ratios of the constituent elements in the drawings do not necessarily reflect actual dimensional ratios.

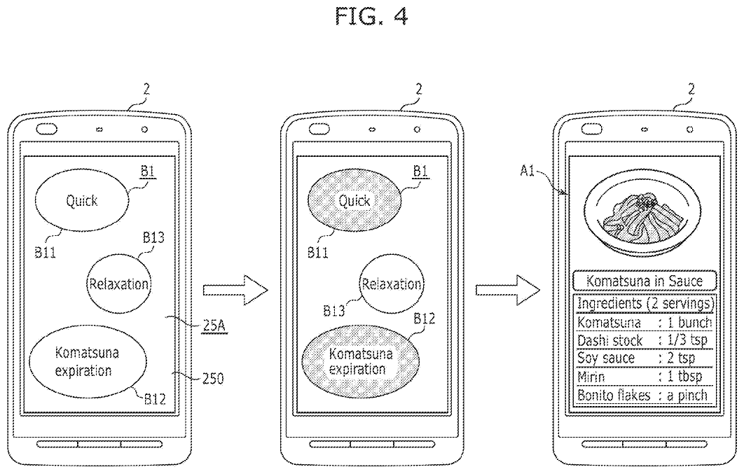

An information presenting method according to the present reference example is a method for presenting a piece of presentation information A1 (see FIG. 4) among a plurality of pieces of presentation information A1 to user 5. Here, as one example, the “presentation information” is assumed to include meal information pertaining to a meal, and in particular, the meal information is assumed to include information pertaining to a cooking menu, a combination of cooking menus, and the like. The meal information is assumed to include information pertaining to a recipe (a cooking method) and information pertaining to eating prepared food and eating out (shop information about restaurants and the like) in addition to the cooking menu. In the following, the cooking menu and the recipe may be collectively referred to simply as a “menu” regardless of the number of menu items (whether one or multiple items), and a recommendation pertaining to presentation information A1 may be referred to as a “menu recommendation”.

Presentation information A1 is not limited to including meal information pertaining to a meal. Presentation information A1 may include information pertaining to music, books, videos, or the like instead of a meal. The present reference example assumes that the information presenting method provides meal information for the same day, the next day, or for a long period of time such as a week or a month, for example.

The information presenting method includes a first determining step, a first presenting step, a second determining step, and a second presenting step.

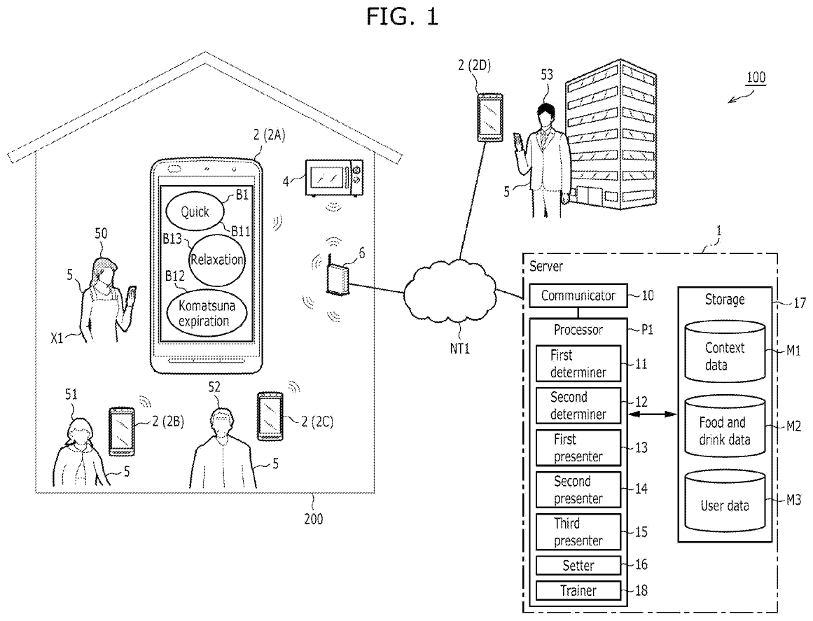

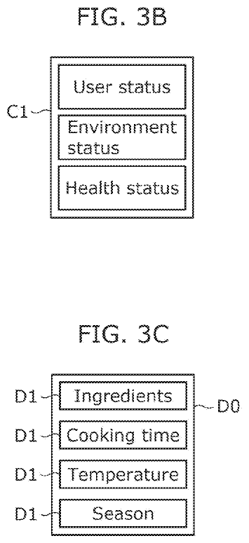

In the first determining step, a plurality of intermediate words B1 are determined based on condition information C1 (see FIG. 3B) related to user 5 (see FIG. 1). A case where the information presenting method is used with a focus on a family in a given residence 200 will be described here as an example. In other words, the information presenting method is used in a unit of group G1 (a single household) including a plurality of users 5 (mother 50, father 53, child 51, and grandfather 52). However, the number of users 5 is not particularly limited, and the information presenting method can be used in units of single users, or can be used in units of organizations, other groups, or the like.

Here, “condition information” is information pertaining to at least one of a user status, a stock status, and an environment status (obtained information), and the information is used to determine whether a predetermined condition is met. The information pertaining to the user status is, for example, information pertaining to the current location of user 5 and information pertaining to a health status and the like of user 5. The information pertaining to the stock status is, for example, information on the types of ingredients stored in residence 200 (e.g., in the freezer/refrigerator), a management date (specifically, an expiration date, a best-before date, or the like). The information pertaining to the environment status is, for example, information about the surrounding environment of residence 200, the temperature, humidity, or season around user 5, or the like.

In the first presenting step, the plurality of intermediate words B1 are presented to user 5 to enable user 5 to select at least one intermediate word B1 from the plurality of intermediate words B1. In the present reference example, the plurality of intermediate words B1 are output (presented) in outputter 25 of terminal device 2, which corresponds to an information terminal owned (e.g., carried) by user 5.

Here, the “information terminal” is a smartphone, a tablet terminal, or the like, for example. The “presenting” is assumed to be performed through screen output from display 25A (see FIG. 4) including a touch panel-type liquid crystal display or an organic electroluminescence (EL) display, for example. However, terminal device 2 is not limited to a portable terminal, and may be a stationary personal computer, for example. The “presenting” is not limited to screen output, but may be performed by audio output instead of or in addition to screen output. For example, terminal device 2 may be a smart speaker in which artificial intelligence (AI) technology is applied, i.e., what is known as an AI speaker. Terminal device 2 may be a smart TV. If not a portable terminal, terminal device 2 can be installed in a kitchen or other location in residence 200.

In the second determining step, presentation information A1 corresponding to at least one intermediate word B1 selected by user 5 is determined from among the plurality of pieces of presentation information A1. In the second presenting step, the determined presentation information A1 is presented to user 5. The second presenting step also basically presents the determined presentation information A1 from the same terminal device 2 as terminal device 2 that presented the plurality of intermediate words B1 in the first presenting step. To give an example of presentation information A1 (meal information), presentation information A1 can include information (text information and image information) pertaining to a cooking menu called “komatsuna in sauce” (see FIG. 4). Presentation information A1 can include, for example, information (text information and image information) pertaining to a recipe (cooking method) for “komatsuna in sauce”.

The presentation destination may differ between the first presenting step and the second presenting step. For example, the presentation in the first presenting step may be made in a smartphone owned by user 5, and the presentation in the second presenting step may be made in a smart TV owned by user 5. Presentation information A1 presented in the second presenting step is not limited to a single piece of information, and may be a plurality of pieces of information.

Here, each of the plurality of intermediate words B1 is a word associated with attribute D1 (see FIG. 3C) related to at least one of the plurality of pieces of presentation information A1. Presentation information A1 (the meal information) can include, for example, a plurality of attributes D1 such as “ingredients” required for the cooking menu, “cooking time” for the cooking menu, “temperature” for the cooking menu, and “season (time of year)” when the cooking menu is prepared. For example, if attribute D1 is ingredients, intermediate words B1 include a word indicating the name of the ingredient, such as “komatsuna”. If attribute D1 is cooking time, intermediate words B1 include a word such as “quick” (can be made quickly), which is associated with cooking time. The “temperature” information in attribute D1 is described here as the temperature of the cooked menu item itself, but the “temperature” information may also be the outside temperature suitable for the cooking menu. For example, the attribute “temperature” of a “hot pot” cooking menu can also be set to outside temperature conditions that cause a sudden feeling of cold (e.g., if the outside temperature is 13 degrees or lower and the temperature is −5 degrees or higher than that day or the day before).

According to the information presenting method of the present reference example, a plurality of intermediate words B1 are determined and presented based on condition information C1 related to user 5 (see FIG. 1), and thus presentation information A1 is presented simply by user 5 selecting intermediate word B1 of interest from the plurality of intermediate words B1. In other words, unlike PTL 1, there is no need for user 5 to think of a search word that corresponds to intermediate word B1 and enter the search word themselves. As a result, there is an advantage in that it is easier to reflect the intentions of user 5 while improving convenience for user 5.

Information presenting system 100 according to another form of the reference example presents one piece of presentation information A1 to a user from among a plurality of pieces of presentation information A1.

As illustrated in FIG. 1, information presenting system 100 includes first determiner 11, first presenter 13, second determiner 12, and second presenter 14.

First determiner 11 determines a plurality of intermediate words B1 based on condition information C1. First presenter 13 presents the plurality of intermediate words B1 to user 5 to enable user 5 to select at least one intermediate word B1 from the plurality of intermediate words B1. Second determiner 12 determines presentation information A1, corresponding to at least one intermediate word B1 selected by user 5, from among the plurality of pieces of presentation information A1. Second presenter 14 presents the determined presentation information A1 to user 5.

In this information presenting system 100 too, there is an advantage in that it is easier to reflect the intentions of user 5 while improving convenience for user 5.

Note that the present reference example assumes that the functions of first determiner 11, first presenter 13, second determiner 12, and second presenter 14 are all integrated and incorporated into server 1 that can communicate with one or more terminal devices 2. However, at least some of these functions may be incorporated into a device other than server 1. Server 1 is assumed to be constituted by a single server device, but may also be constituted by a plurality of server devices, and such server devices may be used to construct a cloud (for cloud computing), for example.

Information presenting system 100 in the present reference example, for example, manages historical information pertaining to intermediate words B1 and the like selected by user 5 on a daily basis, and determines a plurality of intermediate words B1 that match a lifestyle pattern (lifestyle habits, lifestyle rhythm) and preferences of user 5 through machine learning.

### (2) Details

The configuration of information presenting system 100 according to the present reference example will be described in detail below with reference to FIGS. 1 to 5.

### (2.1) Overall Configuration

Information presenting system 100 is configured to present one piece of presentation information A1 to user 5 from among a plurality of pieces of presentation information A1. Here, information presenting system 100 is configured to execute recommendation processing for recommending a “menu” in response to a request from user 5. Information presenting system 100 includes one or more terminal devices 2 and server 1. As mentioned above, focusing on a plurality of users 5 (family members) living in a given residence 200, information presenting system 100 further includes (microwave) range device 4, which is a cooking appliance installed in the residence, and router 6, which is also installed in the residence. However, information presenting system 100 is not limited to being applied to family members living in residence 200, as long as the users require the service for providing meal information pertaining to meals (presentation information A1).

Assume that the family living in residence 200 consists of four users 5, namely mother 50, father 53, child 51, and grandfather 52, and that, as an example, mother 50 cooks meals for the entire family each day. Therefore, it is mainly mother 50 (cook X1) who desires assistance (provision of presentation information A1) from information presenting system 100 regarding the daily menu. Of course, a family member other than mother 50 (e.g., father 53) may be cook X1 on a temporary basis as a substitute for cook X1.

In the present reference example, as illustrated in FIG. 1, each of the family members (the plurality of users 5) owns (carries) one terminal device 2. Mother 50 owns terminal device 2A, child 51 owns terminal device 2B, grandfather 52 owns terminal device 2C, and father 53 owns terminal device 2D.

Each terminal device 2 is assumed to be a portable information terminal such as a smartphone as an example, as described above. Each terminal device 2 is communicatively connected to router 6 installed in the residence when user 5 carrying terminal device 2 is in residence 200. Each terminal device 2 communicates with router 6 wirelessly in accordance with a standard such as Wi-Fi (registered trademark), for example. Router 6 can also be communicatively connected to various electronic devices in the residence. In the present reference example, range device 4 corresponds to one electronic device that can communicate with router 6. Each terminal device 2 can then communicate wirelessly with range device 4 via router 6. Other electronic devices that can communicate with router 6 include freezers, refrigerators, ovens, and rice cookers, as well as other cooking devices. If a Home Energy Management System (HEMS) is installed in residence 200, an HEMS controller is also communicatively connected to router 6. Router 6 is connected to network NT1 such as the Internet (see FIG. 1). Each terminal device 2 and various electronic devices can communicate with server 1 outside residence 200 via router 6. Server 1 will be described in detail in the next section.

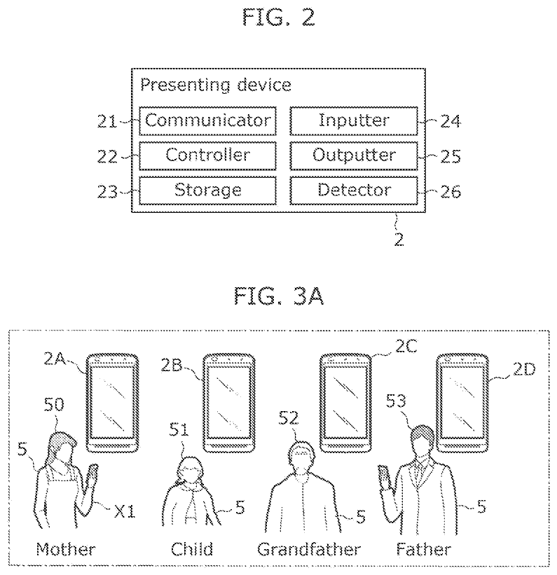

As illustrated in FIG. 2, each terminal device 2 includes communicator 21, controller 22, storage 23, inputter 24, outputter 25, and detector 26. Each terminal device 2 is pre-installed with dedicated application software (called simply a “cooking app” hereinafter) for communicating with range device 4, server 1, and the like to present a graphical user interface (GUI) pertaining to a meal.

Communicator 21 is a communication interface for communicating with range device 4, server 1, and the like. Each terminal device 2 transmits and receives data to and from range device 4, server 1, and the like via communicator 21.

Controller 22 is configured to control terminal device 2 as a whole, i.e., control communicator 21, controller 22, storage 23, inputter 24, outputter 25, and detector 26. Controller 22 can be implemented by, for example, a computer system including one or more processors (microprocessors) and one or more memories. In other words, by executing one or more programs (applications) stored in one or more memories, the one or more processors function as controller 22. Although recorded in memory of controller 22 in advance here, the programs may be provided over a telecommunication line such as the Internet or having been recorded in a non-transitory recording medium such as a memory card.

Storage 23 is constituted by readable/writable memory. Storage 23 is, for example, flash memory. Storage 23 is provided outside of controller 22, but may also be provided inside controller 22. In other words, storage 23 may be internal memory of controller 22. Storage 23 stores various data.

Inputter 24 is a user interface that accepts input operations from user 5, and here, a touch panel display (display 25A) attached to terminal device 2 also functions as inputter 24. In sum, user inputs are accepted by user 5 performing operations (e.g., tapping) on display screen 250 of display 25A using their fingertips or the like. A microphone attached to terminal device 2 may also function as inputter 24 (voice input). Inputter 24 accepts user inputs regarding the cooking app. In particular, inputter 24 accepts inputs for user 5 to select intermediate word B1 or presentation information A1 of interest from the “presented plurality of intermediate words B1” or the “presented presentation information A1” described above.

Outputter 25 is a user interface that outputs (presents) various information to user 5, and here, touch panel display 25A provided in terminal device 2 also functions as outputter 25. A speaker attached to terminal device 2 may also function as outputter 25. Outputter 25 outputs information pertaining to the cooking app to user 5. In particular, outputter 25 executes “presentation” by outputting image data, character string data, and the like related to a tag (object image) of intermediate word B1 and presentation information A1 from display 25A, and by outputting audio data related to intermediate word B1 and presentation information A1 from the speaker.

Detector 26 is configured to detect the user status of user 5 carrying their device (terminal device 2). Detector 26, for example, uses a satellite positioning system such as Global Positioning System (GPS) to obtain the current location information of the device, and detects the current location (user status) of user 5 carrying terminal device 2 based on that location information. Controller 22 transmits information pertaining to the current location of user 5 detected by detector 26 to server 1 via communicator 21. The user status detected by detector 26 is not limited to the current location (coordinates) of user 5. Detector 26 functions as a thermo-hygrometer, detects the ambient temperature, and transmits information pertaining to the temperature (the environment status) to server 1 via communicator 21.

Detector 26 functions as a pedometer, and the user status may be a number of steps, calories burned, walking time, walking speed, and the like of user 5. Detector 26 may also have a function for extracting a feature from a subject in an image captured by an imager (camera) attached to terminal device 2, and the user status may be a feature from the image.

The function of detector 26 is not limited to being provided in terminal device 2, and may instead be provided in a device external to terminal device 2. In this case, it is preferable that the external device be capable of communicating with terminal device 2 or server 1 via router 6. For example, a blood pressure monitor installed in the residence may detect a blood pressure value (the user status) of user 5 and transmit a detection result to terminal device 2 or server 1.

By starting the cooking app in terminal device 2 and entering a user ID and password provided in advance by the provider of the cooking app in a login screen, user 5 can accept various services related to meal information associated with the user ID.

When user 5 starts the cooking app at a desired timing in terminal device 2 and makes an operational input to request a menu recommendation, terminal device 2 sends a menu request signal including the user ID and the like to server 1. Using the reception of the menu request signal from terminal device 2 as a trigger, server 1 executes individual adaptive menu recommendation processing that uses artificial intelligence (AI) technology such that a menu suitable for user 5 having that user ID can be recommended.

### (2.2) Server

Server 1 is installed outside of residence 200. Server 1 can be operated, for example, by a party who provides a service (a provider) in which meal information pertaining to a meal (presentation information A1) is provided to user 5, for example. As described above, server 1 is constituted by one server device, as an example.

Server 1 collects and manages various information from the plurality of users 5 who receive services pertaining to presentation information A1 via terminal device 2 and the like. Focusing on a family (four users 5) in residence 200, server 1 manages personal information (user ID, name, address, telephone number, email address information, and the like) of the four family members. Server 1 also manages group information indicating that the four family members (four user IDs) constitute one group G1 (see FIG. 3A), identification information of terminal devices 2 of the four family members, user IDs, and passwords. Furthermore, server 1 manages location information of residence 200, identification information of the cooking appliances (range device 4) in residence 200, and the like.

The information pertaining to the family members in residence 200 described above is managed by server 1 as user data M3 (see FIG. 1). Server 1 also provides a service of presenting presentation information A1 to other users 5 other than the family members of residence 200 (e.g., in other residences), and also collects the information of other users 5 and manages that information as user data M3.

As illustrated in FIG. 1, server 1 includes communicator 10, processor P1, and storage 17.

Communicator 10 is a communication interface for bidirectional communication with terminal device 2 of each user 5 and cooking appliances such as range device 4 via network NT1.

Storage 17 is constituted by readable/writable memory. Storage 17 is, for example, flash memory. Storage 17 is provided outside of processor P1, but may also be provided inside processor P1. In other words, storage 17 may be internal memory of processor P1. Storage 17 stores various data. In particular, storage 17 stores (holds) context data M1, food and drink data M2, and user data M3, as illustrated in FIG. 1.

Processor P1 is configured to perform overall control processing of server 1. Processor P1 can be implemented by, for example, a computer system including one or more processors (microprocessors) and one or more memories. In other words, by executing one or more programs (applications) stored in one or more memories, the one or more processors function as processor P1. Although recorded in memory of processor P1 in advance here, the programs may be provided over a telecommunication line such as the Internet or having been recorded in a non-transitory recording medium such as a memory card.

Here, processor P1 includes first determiner 11 and second determiner 12, as illustrated in FIG. 1. In other words, processor P1 functions as first determiner 11 and second determiner 12. Processor P1 further includes first presenter 13, second presenter 14, third presenter 15, and setter 16, as illustrated in FIG. 1. In other words, processor P1 has the functions of first presenter 13, second presenter 14, third presenter 15, and setter 16.

First determiner 11 is configured to determine the plurality of intermediate words B1 based on condition information C1 associated with user 5 (the first determination step). Upon receiving a menu request signal from terminal device 2, first determiner 11 determines a plurality of intermediate words B1 based on the user ID included in the menu request signal.

Intermediate word B1 will be described here. Intermediate word B1 is a word associated with attribute D1 (see FIG. 3C) related to at least one of the plurality of pieces of presentation information AI. FIG. 3C is a conceptual diagram pertaining to attribute group DO constituted by a plurality of attributes D1. Master information of each piece of presentation information A1 in server 1 is stored in food and drink data M2 in storage 17, in association with the information pertaining to the plurality of attributes D1 in attribute group DO.

Specifically, for example, the master information for the cooking menu “hot-pot chowder” (presentation information A1) is associated with the information “tofu”, “Napa cabbage”, “salmon”, “carrot” and “konnyaku noodles” as the “ingredient” attribute D1. The master information for “hot-pot chowder” is associated with the information “40 minutes” as the “cooking time” attribute D1, for example. The master information for “hot-pot chowder” is associated with the information “80 degrees” as the “temperature” attribute D1, for example. The master information for “hot-pot chowder” is associated with the information “winter” as the “season” attribute D1, for example. With respect to “hot-pot chowder”, intermediate word B1 is a word associated with the ingredients (tofu, Napa cabbage, salmon, carrot, and konnyaku noodles), cooking time (40 minutes), temperature (80 degrees), and season (winter) for “hot-pot chowder”. Intermediate word B1 may be a word that includes the name of the ingredient itself, a word “quick” associated with the cooking time (40 minutes), or a word such as “warm” or “hot pot” (in season) associated with the temperature (80 degrees) or the season (winter). As a result, the cooking menu “hot-pot chowder” is associated with a plurality of intermediate words B1, such as “tofu”, “quick”, “warm”, and “hot pot”.

Server 1 performs data analysis pertaining to data obtained from external servers or meals submitted by individuals, and periodically updates information regarding the type of attribute D1, specific cooking times and temperatures, and the like.

Condition information C1 will be described next. Condition information C1 is obtained information that is automatically obtained beforehand or in real time from terminal device 2 of user 5 or the like. In other words, condition information C1 is information that does not need to be entered by user 5 themselves when requesting menu recommendations. However, condition information C1 may include some information that is entered by user 5 themselves at that time. For example, if user 5 wishes to limit the number of the plurality of intermediate words B1 presented (e.g., to five or fewer), information specifying the number of intermediate words may be entered at that time as condition information C1.

Condition information C1 includes information pertaining to statuses (context), such as user status, stock status, and environment status, as illustrated in FIG. 3B and in Table 1 below. In other words, condition information C1 is information, related to user 5, that can change on a daily basis.

TABLE 1

| | Obtained | Context | Intermediate |
|---|---|---|---|
| | information | conditions | word examples |
| User status | Time | After 7:00 PM | Quick |
| | information | Sat, Sun, | Eating out |
| | | holidays | Eating prepared |
| | | | food |
| | Location | Outside the | Eating out |
| | information | home | Eating prepared |
| | | More than 5 km | food |
| | | from home | Relaxation |
| | | Moving | |
| | Health | Higher than | Diet |
| | information | standard BMI | Blood sugar |
| | | higher than | level |
| | | standard blood | Low-calorie |
| | | sugar level | |
| Stock status | Stock | Ingredient | Stocked |
| | information | having expiration | ingredient name |
| | | date within one | (ex: komatsuna) |
| | | day present | |
| Environment | Temperature | At least 4 | Warm |
| status | information | degrees lower | Hot pot |
| | | than the previous | |
| | | day's | |
| | | temperature | |

### User Status

The user status can include time information, location information, health information, and the like, for example, as indicated in Table 1. Note that the context conditions and intermediate word examples indicated in Table 1 are merely examples, and are not limited thereto. In information presenting system 100, intermediate word B1 corresponding to the example conditions can be changed on a daily basis based on the selections made by user 5 (historical information) to better suit personal preferences and the like. The “historical information” will be described in detail in the next section.

The time information is information pertaining to the timing when user 5 requested the menu recommendation, and is included in the menu request signal and transmitted from terminal device 2. Here, the time information includes information on the year, month, day, time, and day of the week, but may be information on the time only, for example. The time information may be based on time measured by a timer of server 1, or may be information pertaining to the timing when the menu request signal was received. The time information is then used to determine whether predetermined context conditions are met. Examples of the predetermined context conditions for the time information include “after 7:00 PM”, “weekends and holidays”, and the like, as indicated in Table 1. If the time information meets at least one of the context conditions of “after 7:00 PM” and “weekends and holidays,” first determiner 11 can determine the words “quick”, “eating out”, and “eating prepared food” as intermediate words B1.

The location information is information pertaining to the current location (position) of user 5. Here, the location information is information pertaining to the current location of user 5 as detected by detector 26. The location information of user 5 who requested the menu recommendation is transmitted from terminal device 2, included in the menu request signal. The location information is not only the current location of user 5 who requested the menu recommendation, but information pertaining to the current location of other users 5 in the family is transmitted from terminal device 2 of each of the other users 5. Server 1, for example, transmits a signal requesting the transmission of the location information to terminal device 2 of the other users 5 in the family at the timing that the menu request signal is received. The location information is then used to determine whether predetermined context conditions are met. Examples of the predetermined context conditions for the location information are “outside the home”, and “at least 5 km away from the home”, and “moving (e.g., on the way home)”, as indicated in Table 1. If the location information meets at least one of the context conditions of “outside the home”, “at least 5 km away from the home”, and “moving”, first determiner 11 can determine words such as “eating out”, “eating prepared food”, and “relaxation” as intermediate words B1.

The health information is information pertaining to the current health status of user 5, and is managed in advance by server 1, for example. User 5 can register, change, and delete the health information at any time, for example, by launching the cooking app on terminal device 2. The health information includes, for example, age, height, weight, vision, hearing, blood pressure, blood sugar level, and names of pre-existing medical conditions, and the information is transmitted from terminal device 2 to server 1. Some of the health information may be transmitted directly from an external device (e.g., a blood pressure monitor) to server 1, as described above. Server 1 stores and manages this information as user data M3 in storage 17. Of course, if user 5 does not wish to register information pertaining to their health status, it is not necessary to input this information. The health information is then used to determine whether predetermined context conditions are met. Examples of predetermined context conditions for the health information are “higher than standard body mass index (BMI)”, “higher than standard blood sugar level”, and the like, as indicated in Table 1. If the health information meets at least one of the context conditions of “higher than standard BMI” and “higher than standard blood sugar level”, first determiner 11 can determine words such as “diet”, “blood sugar level” and “low-calorie” as intermediate words B1.

### Stock Status

Stock status can include stock information pertaining to ingredients, for example, as indicated in Table 1. In other words, the stock information is information on the ingredients that user 5 purchases (or receives) and stores in a refrigerator or the like in residence 200. In this case, the stock information includes the name, type (genres such as meat, seafood, beans, grains, fresh vegetables, fresh fruits, and mushrooms), storage location, remaining amount (quantity, weight, and the like), date of purchase, management date, and the like of the ingredients. The management date is assumed to be, for example, an expiration date, a best-before date, or the like, but may also be a date set as desired by user 5 (e.g., a date set prior to the expiration date). User 5 can register, change, and delete the stock information at any time, for example, by launching the cooking app on terminal device 2. This information is transmitted from terminal device 2 to server 1. Server 1 stores and manages this information as user data M3 in storage 17. Of course, if user 5 does not wish to register stock information, it is not necessary to input this information. If a one-dimensional code or a two-dimensional code is attached to the packaging material or the like in which the purchased ingredient is packaged, terminal device 2 may transmit the stock information, including the expiration date and the like, to server 1 by reading the code using the imager of terminal device 2.

Server 1 manages the stock information on the ingredients being stored by user 5. When user 5 inputs information to terminal device 2 indicating that they actually cooked the meal indicated in presentation information A1 recommended by information presenting system 100, terminal device 2 transmits a feedback signal including that information to server 1. When user 5 cooks using range device 4, range device 4 transmits a feedback signal including information on the cooking menu to server 1. From these feedback signals, server 1 estimates the type and amount (quantity, weight, and the like) of the ingredients used and updates the stock information in user data M3 (reducing the information by the amount used). Of course, the stock information in user data M3 may be updated by terminal device 2 directly accepting the input, from user 5, of information indicating the amounts of ingredients actually used.

The stock information is then used to determine whether predetermined context conditions are met. “Ingredient having expiration date within one day present” and the like is an example of the predetermined context conditions for the stock information, as indicated in Table 1. If there is an ingredient that meets the context condition of “ingredient having expiration date within one day present” in the stock information, first determiner 11 can determine a word including the name of the ingredient, e.g., “komatsuna expiration”, as intermediate word B1. In other words, “komatsuna expiration” is intermediate word B1 corresponding to the fact that the expiration date of the komatsuna currently stored by user 5 is within one day.

In this manner, first determiner 11 has a function for determining intermediate word B1 based on the management dates pertaining to ingredients. In other words, the first determining step includes a determination based on the management date pertaining to an ingredient.

### Environment Status

The environment status can include temperature information, for example, as indicated in Table 1. The temperature information is the temperature information of the location area (e.g., city AA) where residence 200, which is the residence facility of user 5, is located. Server 1 identifies the temperature information in the location area from the location information of residence 200 stored in storage 17. For example, server 1 obtains, from an external server (a server that manages weather data), the temperature information for city AA at the time the menu request signal is received. The temperature information need not be the temperature information for the location area of residence 200, but may instead be the temperature information at the current location of user 5 detected by detector 26.

The temperature information is then used to determine whether predetermined context conditions are met. Examples of the predetermined context conditions for the temperature information include “at least 4 degrees lower than the previous day's temperature” and the like, as indicated in Table 1. If the temperature information meets this context condition, first determiner 11 can determine words such as “warm” or “hot pot” as intermediate words B1.

In the present reference example, the master information pertaining to the context conditions and intermediate word examples described above is stored in storage 17 as context data M1, as illustrated in FIG. 1. The context conditions and intermediate word examples are associated with each other and stored in a “many-to-many” manner. Server 1 analyzes data obtained from an external server, data posted by individuals, and the like for context data M1, collects the latest words (e.g., trending words and the like), and updates the words on a daily basis (reinforces context data M1).

First presenter 13 is configured to present the plurality of intermediate words B1 to user 5 to enable user 5 to select at least one intermediate word B1 from the plurality of intermediate words B1 (the first presenting step). Specifically, first presenter 13 generates a signal including information pertaining to the plurality of intermediate words B1 determined by first determiner 11 (a context selection signal) and transmits the signal via communicator 10 to terminal device 2, which is the source of the menu request signal. For example, if a menu request signal is transmitted from terminal device 2A of mother 50, first presenter 13 transmits a context selection signal to terminal device 2A and causes the signal to be output from outputter 25 of terminal device 2A. In other words, as an example here, the selection authority to select one or more intermediate words B1 from the plurality of intermediate words B1 is given to mother 50 who owns terminal device 2A.

When communicator 21 of each terminal device 2 (in this case, terminal device 2A of mother 50) receives the context selection signal, controller 22 displays each of the plurality of intermediate words B1 in display screen 250 of display 25A, which functions as outputter 25, as illustrated in FIG. 4. In the example in FIG. 4, three intermediate words B1 are presented, namely “quick”, “relaxation”, and “komatsuna expiration”. In the example in FIG. 4, the three intermediate words B1 are indicated by circular or elliptical tags. First tag B11 indicates intermediate word B1 “quick”. Second tag B12 indicates intermediate word B1 “komatsuna expiration”. Third tag B13 indicates intermediate word B1 “relaxation”. Each of first tag B11 to third tag B13 can select the corresponding intermediate word B1 by accepting a tap operation by the fingertip or the like of user 5.

It is preferable for terminal device 2 to output a message (character string data or audio data) from outputter 25 prompting the user to select one or more intermediate words B1 from the three intermediate words B1.

Incidentally, first tag B11 to third tag B13 all differ from each other in terms of the region sizes displayed in display screen 250. In the example in FIG. 4, the region size of second tag B12 is the largest, followed by the region size of first tag B11, and the region size of third tag B13 is the smallest. Information presenting system 100 in the present reference example sets the region size of the corresponding tags to be larger for intermediate words B1 estimated to be of greater interest to user 5 who is the transmission source of the menu request signal.

Specifically, first determiner 11 determines an index of “recommendation level” for each of the plurality of intermediate words B1 determined, and first presenter 13 also transmits the context selection signal including a result pertaining to the index. The “recommendation level” may be an absolute index of each intermediate word B1 or a relative index among the plurality of intermediate words B1. The “recommendation level” is determined, for example, by mutual judgment based on the degree to which condition information C1 of user 5 matches the context conditions and the historical information of past selections made by user 5 in user data M3 stored in storage 17. If user 5 places a limit on the number of the plurality of intermediate words B1 to be presented, e.g., no more than five, and if the number of applicable intermediate words B1 is six or more, first presenter 13 causes only the top five intermediate words B1 having the highest “recommendation level” to be presented.

Controller 22 of terminal device 2 determines the region size of each tag based on the “recommendation level” included in the context selection signal and displays the tag in display screen 250. Changing the region size of the tag according to the “recommendation level” is not required, and first tag B11 to third tag B13 may all have the same region size.

When user 5 finds intermediate word B1 of high interest among the plurality of intermediate words B1 displayed in display screen 250, they tap the tag corresponding to that intermediate word B1 with a fingertip or the like. In the example in FIG. 4, first tag B11 and second tag B12 are selected through a tapping operation (see the dot hatching of terminal device 2 in the center of FIG. 4), but the tags may be selected one at a time or all at once. If user 5 is unable to find a word of interest among the plurality of intermediate words B1 displayed in display screen 250, they tap an object region (not shown in FIG. 4) to request the intermediate words to be re-presented. Information presenting system 100 then accepts the request to re-present the items. When server 1 receives a signal regarding the request to re-present from terminal device 2, first determiner 11 extracts a different intermediate word B1 from the plurality of intermediate words B1 presented the previous time.

When one or more intermediate words B1 are selected from the plurality of intermediate words B1 by user 5, controller 22 of terminal device 2 generates a signal indicating the selected intermediate words B1 (a food and drink request signal) and transmits the signal to server 1 via communicator 21. Upon receiving the food and drink request signal, server 1 determines presentation information A1 using second determiner 12, which will be described later. Processor P1 stores a selection result from user 5 (including the request to re-present, i.e., intermediate words B1 of interest to (selected by) user 5 and intermediate words B1 not of interest to (not selected by) user 5, as the historical information (user data M3) in storage 17. Processor P1 then reflects the selection result from user 5 in the next and subsequent determinations of intermediate words B1.

Second determiner 12 is configured to determine presentation information A1, corresponding to at least one intermediate word B1 selected by user 5, from among the plurality of pieces of presentation information A1 (the second determining step). Specifically, upon receiving, from terminal device 2, a food and drink request signal indicating intermediate word B1 selected by the user via communicator 10, second determiner 12 refers to the master information, i.e., food and drink data M2 in storage 17, and extracts presentation information A1 corresponding to that intermediate word B1. Food and drink data M2 is stored in storage 17 in a “many-to-many” format, with the menu name and the corresponding intermediate words B1 associated with each other, as indicated in Table 2 below. In food and drink data M2, each menu name is stored in correspondence with the required ingredients, including the amount. Although not described here, in food and drink data M2, each menu name is also stored in association with a recipe (cooking method). In other words, the meal information in the present reference example includes information pertaining to the cooking menu. Food and drink data M2 is also associated with the cooking appliances required to cook each menu item, e.g., one of the cooking appliances corresponds to range device 4. Note that range device 4 also manages information pertaining to food and drink data M2, and if user 5 cooks a certain menu item using range device 4, the information thereof is transmitted directly from range device 4 to server 1.

TABLE 2

| Menu | Ingredient: | Intermediate |
|---|---|---|
| name | quantity | word examples |
| Hot-pot | Napa cabbage: ½ | Warm |
| chowder | Tofu: 1 pack | Hot pot |
| | Salmon: 2 pieces | |
| | Carrot: 1 | |
| | Konnyaku noodles: one | |
| | pack | |
| Komatsuna | Komatsuna: 1 bunch | Quick |
| in sauce | Dashi stock: ⅓ tsp. | Komatsuna |
| | Soy sauce: 2 tsp. | expiration |
| | Mirin: 1 tbsp. | |
| | Bonito flakes: a pinch | |

Second determiner 12 extracts, from food and drink data M2 in storage 17, presentation information A1 (the menu) including the menu name corresponding to one or more intermediate words B1 selected by user 5. Here, because user 5 has selected two intermediate words B1, namely “quick” and “komatsuna expiration”, in terminal device 2, one or more menu names associated with both of these two intermediate words B1 can be selected.

Specifically, intermediate word B1 “quick” is also associated with other cooking menus in food and drink data M2, e.g., “salmon porridge”, “omelet sandwich”, and “oyakodon”, and the like, in addition to “komatsuna expiration”. Likewise, intermediate word B1 “komatsuna expiration” is also associated with other cooking menus in food and drink data M2, such as “sauteed komatsuna with garlic”, in addition to “komatsuna in sauce”. In this case, second determiner 12 selects “komatsuna in sauce”, which is associated with both “quick” and “komatsuna expiration”. In this manner, second determiner 12 has a function for determining the cooking menu based on the management dates pertaining to ingredients. In other words, the second determining step includes a determination based on the management date pertaining to an ingredient.

Similarly, in the example in Table 2, if user 5 selects two intermediate words B1, namely “warm” and “hot pot”, in terminal device 2, a menu name associated with both of these two intermediate words B1 (hot-pot chowder or the like) can be selected.

Second presenter 14 is configured to present the determined presentation information A1 to user 5 (the second presenting step). Specifically, second presenter 14 generates a signal including information pertaining to one or a plurality of pieces of presentation information A1 determined by second determiner 12 (here, the menu name “komatsuna in sauce”, the required ingredients, the recipe, an image of the cooking menu, and the like) (a menu presentation signal). Second presenter 14 then transmits the menu presentation signal via communicator 10 to terminal device 2 that is the source of the food and drink request signal. For example, if a food and drink request signal is transmitted from terminal device 2A of mother 50, second presenter 14 transmits a menu presentation signal to terminal device 2A and causes the signal to be output from outputter 25 of terminal device 2A. The image of the cooking menu may be an image prepared in advance on the part of the provider who operates server 1, or may be menu images captured and posted to server 1 by individuals.

When communicator 21 of each terminal device 2 (here, terminal device 2A of mother 50) receives the menu presentation signal, controller 22 displays presentation information A1 in display screen 250 of display 25A, as indicated by the rightmost terminal device 2 in FIG. 4. In the example illustrated in FIG. 4, information pertaining to the menu name “komatsuna in sauce” (character string data), an image of the menu (image data), and the required ingredients (character string data) are displayed in the screen as presentation information A1. By tapping on the display column showing the required ingredients, the display transitions to a screen that displays more detailed information (recipes and the like). In the example in FIG. 4, only one piece of presentation information A1 is presented (a single dish called “komatsuna in sauce”), but a plurality of pieces of information can of course be presented. Presentation information A1 may further include information on the salt content, calories, and nutritional content of the cooking menu, as well as the cooking appliance used (e.g., range device 4).

Information presenting system 100 in the present reference example accepts selections for presentation information A1 by, for example, user 5 tapping within a predetermined region displaying one or a plurality of pieces of presentation information A1 in display screen 250 with a fingertip or the like. In other words, if a menu of interest to user 5 (e.g., a menu that they may want to cook in the future) is present among the one or more menus presented, that menu is selected. Through this selection, information presenting system 100 accepts that user 5 will now perform the cooking of that menu item (a final selection for presentation information A1).

Terminal device 2 transmits a signal including the selection result (a feedback signal) to server 1. Upon receiving the feedback signal from terminal device 2 via communicator 10, processor P1 of server 1 assumes that user 5 has actually cooked that menu item based on the selection result. Then, processor P1 estimates the types and amounts (quantity, weight, and the like) of the ingredients that can be used in the menu, and updates the stock information in user data M3 (reducing the information by the amount that can be used). Processor P1 also stores a selection result from user 5, i.e., presentation information A1 of interest to (selected by) user 5 and presentation information A1 not of interest to (not selected by) user 5, as the historical information (user data M3) in storage 17. In other words, similar to the selection result for intermediate words B1, processor P1 also reflects the selection result for presentation information A1 in the next and subsequent decisions for intermediate words B1.

It is preferable that only cook X1 who actually does the cooking (e.g., mother 50) is given the authority to make the “final selection” for presentation information A1. Accordingly, in information presenting system 100, it is possible to set a cook flag indicating that the cook is cook X1 for the user ID in user data M3 in storage 17. Processor P1 of server 1 determines whether the cook flag is assigned to the user ID of the transmission source of the feedback signal, and considers user 5 to have actually cooked the menu only when the cook flag is set. If a feedback signal in which a cook flag is not assigned is transmitted from the user ID, server 1 is notified by terminal device 2 to that effect.

Third presenter 15 is configured to present a preservation method for a specific ingredient when user 5 exhibits behavior that negates the consumption of the specific ingredient (a third presenting step). For example, according to the example above, assume that the expiration date of komatsuna, which is one of the ingredients stored by user 5, is within one day, and that first presenter 13 has presented intermediate word B1 “komatsuna expiration” with the plurality of intermediate words B1. However, if user 5 does not select “komatsuna expiration” and selects another intermediate word B1, second presenter 14 is more likely to present a cooking menu (presentation information A1) that does not use komatsuna. As a result, it is more likely that cook X1 (e.g., mother 50) will make a final selection of a cooking menu that does not use komatsuna, despite the fact that the expiration date of the komatsuna is approaching.

If user 5 selects intermediate word B1 of the category “eating out” or “eating prepared food”, they are more likely to eat out or purchase pre-cooked food (e.g., prepared side dishes) outside, despite the fact that the expiration date of the komatsuna is approaching. As a result, it is more likely that behavior (eating out, eating prepared food) will be taken that negates the consumption of komatsuna despite the fact that the expiration date of the komatsuna is approaching.

Third presenter 15 presents the preservation method for ingredients in such a state (specific ingredients). Specifically, information such as, for example, washing komatsuna for which the expiration date is approaching, cutting the komatsuna into small pieces, and freezing it for storage, is presented to terminal device 2 of user 5. The timing for presenting the preservation method is not particularly limited, but for example, the preservation method is presented after user 5 has made the final selection for presentation information A1. The information pertaining to the preservation method is stored in storage 17 in association with each ingredient as food and drink data M2. Information presenting system 100 also prompts the komatsuna to be preserved by presenting the preservation method. Note that information presenting system 100 may only prompt the user to preserve the ingredient without presenting a preservation method (i.e., output a message prompting the user to preserve the ingredient). Since some types of ingredients may be difficult to preserve (e.g., eggs, dairy products, and the like), if it is determined that such ingredients will reach the expiration dates, information presenting system 100 may output a message prompting those ingredients to be disposed of.

In this manner, third presenter 15 presents the preservation method for the ingredient when user 5 exhibits behavior that negates the consumption of the ingredient, which can improve the convenience.

Setter 16 is configured to set group G1 that includes a plurality of users 5 (see FIG. 3A) (a setting step). Terminal device 2 can accept operational inputs to associate family members of user 5 (mother 50, father 53, child 51, and grandfather 52) as a single group G1 through the cooking app. Upon receiving an operational input regarding group settings, terminal device 2 sends information pertaining to the group settings to server 1. Upon receiving the information pertaining to the group settings from terminal device 2, setter 16 stores the group settings as user data M3 in storage 17. Group G1 is associated by the user IDs of subjects.

In the present reference example, when a menu request signal is received from terminal device 2 of user 5 for which the group settings have been made, at least one of first presenter 13 and second presenter 14 can make a presentation at the level of group G1. In other words, at least one of the first presenting step and the second presenting step performs the presentation at the level of group G1. In this manner, information presenting system 100 can present information at the level of group G1, and can therefore easily present information for a plurality of users 5 (e.g., for the family).

Here, setter 16 is configured to be capable of individually setting the presentation of intermediate words B1 and presentation information A1 to be enabled or disabled, at the level of group G1. For example, assume that the presentation of intermediate words B1 at the level of group G1 is set to “enabled”, and the presentation of presentation information A1 at the level of group G1 is set to “disabled”. When cook X1 (mother 50) performs an operation to transmit a menu request signal from terminal device 2A, a plurality of intermediate words B1 are presented not only to terminal device 2A of mother 50, but also to terminal devices 2 of the other family members (father 53, child 51, and grandfather 52). As a result, each family member can select intermediate word B1 of interest, and presentation information A1 is more likely to reflect the opinions of all family members. At this time, first determiner 11 may determine the plurality of intermediate words B1 based on condition information C1 for all family members, or based on condition information C1 for one representative (e.g., cook X1). The presentation of presentation information A1 is “disabled” and therefore only applies to terminal device 2A of mother 50, who is cook X1. Of course, if the presentation of presentation information A1 at the level of group G1 is also set to “enabled”, presentation information A1 is presented not only to terminal device 2A of mother 50, but also to terminal devices 2 of the other family members.

However, even if the presentation of presentation information A1 at the level of group G1 is set to “enabled”, as described above, it is preferable that only cook X1 who actually does the cooking (e.g., mother 50) is given the authority to make the “final selection” for presentation information A1. In other words, it is preferable that the authority to select presentation information A1 presented in the second presenting step be given only to a predetermined user 5 in group G1. In this case, when an executor who executes a specific action based on the presented presentation information A1 (e.g., cook X1) and a non-executor who does not execute the action are mixed in group G1, the convenience can be improved by providing the authority only to the executor.

### (2.3) Reflection of Historical Information

As described above, in information presenting system 100 of the present reference example, intermediate word B1 corresponding to the example conditions can be changed on a daily basis based on the selections made by user 5 (historical information) to better suit personal preferences and the like. The historical information of user 5 also corresponds to one of the “user statuses” described above. In other words, condition information C1 includes the historical information. The historical information includes a history pertaining to the plurality of intermediate words B1 presented to user 5 by first presenter 13 (the first presenting step) in the past.

In the present reference example, the historical information also includes a history pertaining to one or more intermediate words B1 selected by user 5 in the past. In other words, information presenting system 100 manages historical information pertaining to intermediate words B1 and the like selected by user 5 on a daily basis.

Furthermore, in the present reference example, the historical information includes history pertaining to the behavior of user 5 who received presentation information A1 through second presenter 14 (the second presenting step) in the past. Specifically, the historical information can include history pertaining to presentation information A1 for which the user made a “final selection” (or not selected, but rather viewed) by tapping on terminal device 2, and can also include history pertaining to presentation information A1 that the user “did not select”. The historical information includes a history of cooking a given cooking menu (not necessarily matching presentation information A1) using range device 4, and can include a history based on information received directly from range device 4. In other words, the above-described “behavior” corresponds to selection, browsing, and cooking (execution).

The historical information also includes obtained information pertaining to the user status, stock status, and environment status obtained in the past. For example, the past user status can serve as a basis for estimating the lifestyle patterns (lifestyle habits, lifestyle rhythms) of user 5.

Processor P1 of information presenting system 100 further includes trainer 18 (see FIG. 1) that performs unsupervised learning, for example, based on the historical information accumulated on a daily basis. Trainer 18 analyzes the structure and features of the historical information, performs clustering and the like, and generates a model for each user 5 (or group G1). First determiner 11 determines a plurality of intermediate words B1 that better fit the lifestyle pattern and preferences of user 5 by considering the model in addition to the current status (context) at the timing when the menu request signal is received. The “historical information accumulated on a daily basis” mentioned here can include not only the historical information of user 5 who requested the menu recommendation, but also the historical information of other users 5 in group G1 to which user 5 belongs, and the historical information of users 5 other than users 5 of residence 200.

Examples of the features of the historical information can include, for example, a strong tendency to choose low-calorie or low-sodium menus due to weight or blood pressure concerns, a strong tendency to eat light meals for dinner, and a strong tendency to come home late, after 9:00 PM. Other examples of the features are a strong tendency to prefer cooking hot pot meals during the winter season, a tendency to be unable to manage the expiration dates of ingredients and often have ingredients for which the expiration dates are approaching, and a tendency to eat out more on weekends and be less likely to cook their own meals. In information presenting system 100, such features are more easily reflected in the determination of intermediate words B1.

In this manner, in the present reference example, a plurality of intermediate words B1 are determined based on condition information C1, which includes historical information. Accordingly, it is easier to reflect the lifestyle patterns, preferences, and the like of user 5 in the plurality of intermediate words B1, and as a result, it is easier to present presentation information A1 that better reflects the intentions of user 5.

Note that it is preferable that at least one of first determiner 11 and second determiner 12 make the determination on intermediate word B1 and presentation information A1 based on the management date (pertaining to ingredients) and the lifestyle pattern of user 5, respectively. In other words, it is preferable that at least one of the first determining step and the second determining step includes a decision based on the management date and the lifestyle pattern of user 5. Specifically, for example, if user 5 tends to eat out or eat prepared foods more often, does not cook much, or tends to come home late, there is a high likelihood that ingredients will reach their management date without being consumed. In sum, the frequency of cooking on a weekly basis, for example, can vary depending on user 5. Accordingly, information presenting system 100 adjusts the timing for promoting the consumption of ingredients according to the cooking frequency (the lifestyle pattern of user 5) based on the historical information of each user 5.

As described above, information presenting system 100 analyzes the lifestyle patterns of user 5 from the historical information. Information presenting system 100 presents intermediate words B1 and presentation information A1 pertaining to ingredients for which the management date is approaching to user 5 whose cooking frequency is relatively low, early on with respect to the management date. For example, with respect to one of the context conditions in Table 1, “ingredient having expiration date within one day present”, applying a condition “ingredient having expiration date within three days present” to user 5 whose cooking frequency is relatively low ensures intermediate words B1 pertaining to the management date are presented two days early. In this case, in addition to the management date pertaining to ingredients, recommendations regarding meals can be made taking into account the lifestyle patterns of user 5.

### (2.4) Presentation of Ingredient List

Some users 5 may, for example, decide on menus to a certain degree for a week in advance, and purchase the ingredients used in that week's menus at once. Accordingly, information presenting system 100 of the present reference example enables the user to specify the number of meals for which recommendations are requested. In other words, presentation information A1 is not limited to information pertaining to one meal, and may include information pertaining to two or more meals. Here, “one meal” is assumed to be, for example, one breakfast, lunch, dinner, or one snack per day. However, “one meal” may instead refer to one day's worth of meals. Instead of specifying the “number” of meals, a “period (two days, one week, or the like)” may be specified, e.g., “March 1-March 10” may be specified based on calendar information. The calendar information, along with event information and the like, is stored in storage 17 for each user 5 and managed as user data M3. Each user 5 can view their calendar information via terminal device 2. User 5 can, for example, view menus that have been cooked in the past in the form of a calendar (e.g., cooking menu on February 1: hot-pot chowder). The calendar information can also be used to register planned events (e.g., the date of a planned meal out, the date of a planned business trip for father 53, the date of a scheduled sports day for child 51, and the like) as schedule information. This schedule information also corresponds to one of the “user status” of condition information C1 in the determination of intermediate words B1 by first determiner 11.

When server 1 receives information from terminal device 2 specifying the number of meals for which recommendations are requested, second presenter 14 presents presentation information A1 pertaining to the meals for that number of times. Here, second presenter 14 is configured to present a list of ingredients corresponding to each of two or more meals as a batch, as presentation information A1 (the second presenting step).

Here, server 1 may receive a request from user 5 to re-present presentation information A1, for example, the day after or several days after presenting presentation information A1 corresponding to one week's worth of meals. However, the status (context) of user 5 changes daily, and the stock of the one week's worth of ingredients purchased in bulk will decrease as a result of daily cooking. In response to this, information presenting system 100 of the present reference example is configured to update the ingredient list (presented as a batch) according to changes in condition information C1. Accordingly, when condition information C1 can change on a daily basis, the ingredient list can be presented in a form that reflects the changes. In particular, it is possible to recommend the best menu that can be prepared with the remaining ingredients at the time the request for re-presenting presentation information A1 is received.

It is preferable that the ingredient list be updated according to the results of selections made by user 5 when presentation information A1 was presented in the past. In this case, the ingredient list can be presented in a form that better reflects the lifestyle patterns, preferences, and the like of user 5.

### (2.5) Priority Level

In the present reference example, priority levels can be set for the plurality of users 5 in group G1. Then, if there is a priority level setting, first determiner 11 is configured to determine a plurality of intermediate words B1 based on condition information C1 associated with user 5 having the highest priority level in group G1. In other words, priority levels are set for the plurality of users 5 in group G1, and a plurality of intermediate words B1 are determined in the first determining step based on condition information C1 associated with user 5 having the highest priority level.

The priority levels for group G1 are set as priority level flags from “1” to “3”, for example, as indicated in Table 3 below.

TABLE 3

| First | Second | Family | Priority | Priority |
|---|---|---|---|---|
| identifier | identifier | member | level flag | conditions |
| #1 | #100 | Mother | 3 | |
| | #101 | Father | 3 | |
| | #102 | Child | 1 | Return home |
| | | | | time |
| | #103 | Grandfather | 2 | Blood sugar |
| | | | | level |

In the example in Table 3, a set of a first identifier and a second identifier constitute the user ID of each user 5. The first identifier is a unique ID of group G1, and the second identifier is a unique ID that distinguishes the family members within group G1. A priority level flag of “1” indicates the highest priority, followed by “2” and “3”, indicating lower priority levels. In other words, in the example in Table 3, the highest priority level is assigned to the user ID of child 51. Furthermore, information presenting system 100 of the present reference example can also set priority conditions. User 5 can input priority level flags and priority conditions by making operational inputs in terminal device 2.

For example, first determiner 11 determines intermediate words B1 based on condition information C1 associated with child 51, who has the highest priority level in group G1, i.e., giving priority to the lifestyle patterns, preferences, and the like of child 51. In particular, because the priority condition for child 51 is set to “return home time”, first determiner 11 estimates the return home time based on the current location of child 51 and includes, for example, an intermediate word B1 that associates attribute D1 with a meal that can be cooked so as to match that return home time.

Additionally, first determiner 11 determines intermediate words B1 based on condition information C1 associated with grandfather 52, who has the next-highest priority level in group G1, i.e., giving priority to the lifestyle patterns, preferences, and the like of grandfather 52 after child 51. In particular, because the priority condition for grandfather 52 is set to “blood sugar level”, first determiner 11 includes intermediate word B1, which associates attribute D1 with a meal with low sugar, if the blood sugar level (health information) meets a predetermined context condition.

Because the priority level can be set in this manner, condition information C1 associated with user 5 having the highest priority level is more easily reflected in the plurality of intermediate words B1.

Note that in response to an operational input from user 5, terminal device 2 can output a list of which priority level is set for which person in group G1 on display screen 250, as indicated in Table 3. Accordingly, each user 5 can easily view the current priority level settings for group G1.

### (2.6) Operations

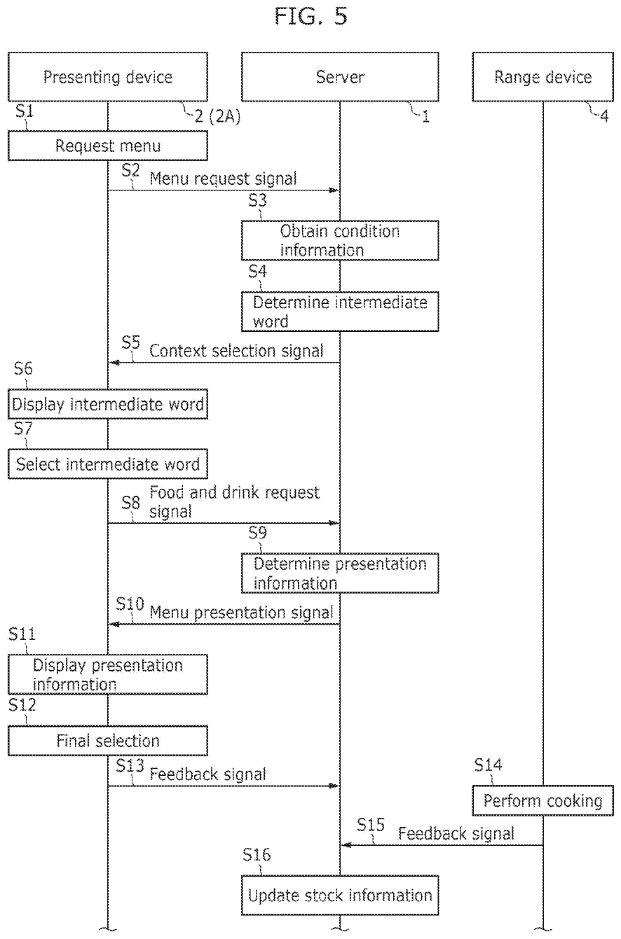

Operations of information presenting system 100 according to the present reference example will be described in detail below with reference to FIG. 5. Note that the order in the following descriptions of the operations is merely an example, and is not particularly limited.

In residence 200, mother 50, who is cook X1, launches the cooking app on terminal device 2A and logs in by entering her user ID and password. Furthermore, mother 50 makes an operational input through the cooking app to request a menu recommendation pertaining to, for example, today's dinner (step S1). Terminal device 2A transmits a menu request signal to server 1 in response to the operational input from mother 50 (step S2).

Upon receiving the menu request signal, server 1 requests and obtains information required in condition information C1 at that time (information such as the current location and the like) from terminal devices 2 of all users 5 in group G1 associated with the user ID (step S3). Server 1 then determines a plurality of intermediate words B1 based on condition information C1 (the first determining step: step S4). As illustrated in FIG. 1, here, mother 50, child 51, and grandfather 52 of the four family members are at home, while father 53 is working at his job and is therefore not at home. Server 1 infers from the current location of father 53 that he is currently at work, and as a result, intermediate words B1 can include words such as those associated with father 53 not being home.

Upon determining the plurality of intermediate words B1, server 1 generates a context selection signal and transmits the signal to terminal device 2A to present the plurality of intermediate words B1 to mother 50 (the first presenting step: step S5).

Upon receiving the context selection signal, terminal device 2A displays the plurality of intermediate words B1 in display screen 250 of display 25A (step S6). Upon accepting the selection of plurality of intermediate words B1 through a tapping operation or the like from mother 50 (step S7), terminal device 2A generates a food and drink request signal indicating the selected intermediate words B1 and transmits the signal to server 1 (step S8).

Upon receiving the food and drink request signal, server 1 determines presentation information A1 corresponding to intermediate words B1 selected by user 5 by referring to food and drink data M2 (the second determining step: step S9). Server 1 generates a menu presentation signal including information pertaining to the determined presentation information A1 (“komatsuna in sauce”, here) and transmits the signal to terminal device 2A to present presentation information A1 to mother 50 (the second presenting step: step S10).

Upon receiving the menu presentation signal, terminal device 2A displays presentation information A1 in display screen 250 of display 25A (step S11). When mother 50 decides to cook the recommended presentation information A1 as today's dinner, she makes a “final selection” through a tapping operation or the like (step S12).

Terminal device 2A transmits a feedback signal including the selection result to server 1 (step S13). When mother 50 executes cooking using range device 4 for presentation information A1 for which the final selection was made (step S14), range device 4 transmits a feedback signal including a cooking result thereof to server 1 (step S15).

Upon receiving the feedback signals from terminal device 2A and range device 4, server 1 estimates the type and amount (quantity, weight, and the like) of ingredients that can be used in the menu based on the selection result and the cooking result, and updates the stock information in user data M3 (step S16). Additionally, at this timing, for example, trainer 18 updates the (machine learning) model to take into account the selection result and cooking result.

In this manner, according to information presenting system 100 of the present reference example, a plurality of intermediate words B1 are determined and presented based on condition information C1 related to user 5, and thus presentation information A1 is presented simply by user 5 selecting intermediate word B1 of interest from the plurality of intermediate words B1. In other words, unlike PTL 1, there is no need for user 5 to think of a word that corresponds to intermediate word B1 and enter the word themselves. As a result, there is an advantage in that it is easier to reflect the intentions of user 5 while improving convenience for user 5.

Compared to when information presenting system 100 starts being used for the first time, the more times intermediate words B1 and presentation information A1 are selected as a result of daily requests for menu recommendations, the easier it is for intermediate words B1 which match the lifestyle patterns, preferences, and the like of user 5 to be presented, due to trainer 18. In particular, cook X1 may not fully grasp the current statuses (context) of other users 5 in group G1 in detail, and in this respect, information presenting system 100 can present intermediate words B1 and presentation information A1 taking into account the statuses of other users 5.

### (3) Variations

The above-described reference example is just one of a variety of reference examples of the present disclosure. As long as the object of the present disclosure can be achieved, various changes can be made on the foregoing reference example in accordance with design or the like. Functions similar to information presenting system 100 according to the above-described reference example may also be embodied in an information presenting method, a computer program, or a non-transitory recording medium having recorded thereon a computer program.

The following will describe variations on the above-described reference example. The variations described below can be applied in combination with each other as appropriate. In the following, the above-described reference example may be referred to as a “basic example”.

Information presenting system 100 according to the present disclosure includes a computer system. The computer system is constituted mainly by a processor and memory as hardware. Functions of information presenting system 100 according to the present disclosure are implemented by the processor executing a program recorded in the memory of the computer system. The program may be recorded in advance in the memory of the computer system, provided over a telecommunication line, or provided having been recorded in a non-transitory recording medium, such as a memory card, an optical disc, a hard disk drive, or the like that can be read by the computer system. The processor of the computer system is constituted by one or more electronic circuits including a semiconductor integrated circuit (IC) or a large-scale integrated circuit (LSI). The integrated circuits referred to by the terms “IC”, “LSI”, and the like are given different names depending on the degree of integration, and include integrated circuits referred to as “system LSI”, “VLSI (Very Large Scale Integration)”, or “ULSI (Ultra Large Scale Integration)”. Furthermore, and FPGA (Field Programmable Gate Array), which is programmed after the manufacture of the LSI circuit, or a logic device capable of reconfiguring connection relationships in the LSI circuit or reconfiguring circuit sections within the LSI circuit, may also be employed as the processor. The plurality of electronic circuits may be provided on a single chip or may be distributed throughout a plurality of chips. The plurality of chips may be provided in a single apparatus or may be distributed throughout a plurality of apparatuses. Here, the computer system includes a microcontroller having one or more processors and one or more memories. Accordingly, the microcontroller is also constituted by one or more electronic circuits including a semiconductor integrated circuit or a large-scale integrated circuit.

It is not necessary for a plurality of functions in information presenting system 100 to be integrated within a single housing. For example, the constituent elements of information presenting system 100 may be distributed throughout a plurality of housings. Conversely, a plurality of functions in information presenting system 100 may be integrated within a single housing. Furthermore, at least some functions of information presenting system 100, e.g., some functions of information presenting system 100, may be realized in the cloud (through cloud computing) or the like.

In the basic example, a plurality of intermediate words B1 are displayed as circular and elliptical tags in display screen 250 of display 25A of terminal device 2. However, as illustrated in FIG. 6, the plurality of intermediate words B1 may be displayed in list format. In the list format as well, it is preferable for intermediate words B1 to be displayed in descending order of “recommendation level” from the top.

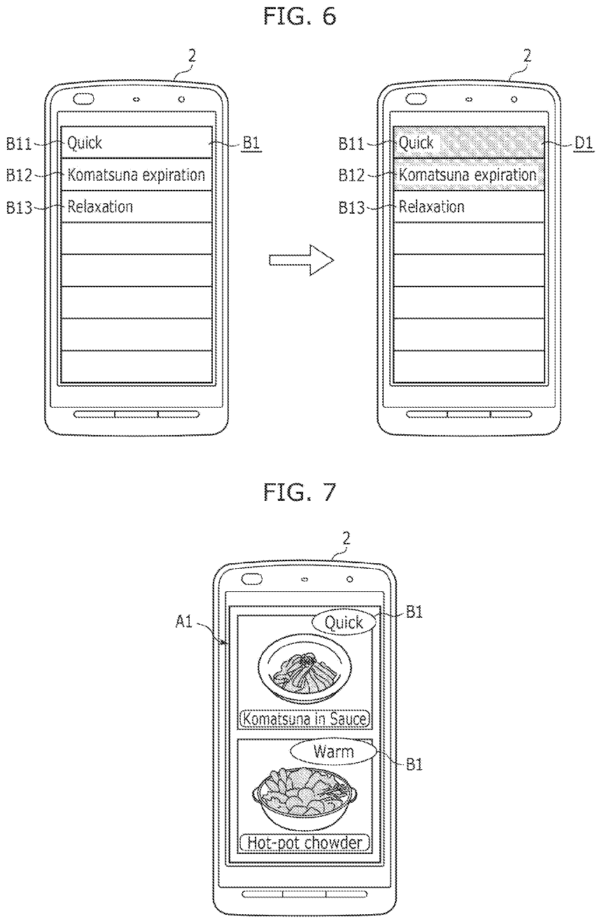

In the basic example, one piece of presentation information A1 is displayed in one screen. However, as illustrated in FIG. 7, two pieces of presentation information A1 (komatsuna in sauce and hot-pot chowder) may be displayed in one screen. Presentation information A1 may be displayed as a set with intermediate words B1 so that user 5 can see intermediate words B1 that caused server 1 to determine presentation information A1. From the example in FIG. 7, it is easy to see that “komatsuna in sauce” was determined based on user 5 selecting intermediate word B1 “quick”, and that “hot-pot chowder” was determined based on user 5 selecting intermediate word B1 “warm”.

In the basic example, the meal information (presentation information A1) was information pertaining to cooking menus and recipes. However, the meal information may also be information pertaining to eating out or eating prepared food. Specifically, if “eating out” or “eating prepared food” is selected by user 5 as intermediate words B1, information presenting system 100 may present, as presentation information A1, shop information such as supermarkets, restaurants, and the like in the area around residence 200. In this case, server 1 obtains and stores map information pertaining to stores such as supermarkets, restaurants, and the like from an external server and searches for stores in the area around residence 200 or inane area on the route from residence 200 to the workplace of father 53. If information pertaining to a supermarket's special offers or a restaurant's point awards is obtained from the external server, server 1 presents the information as an intermediate word B1, such as “special offer” or “point award”. If user 5 shows interest, server 1 recommends the name and location information of the store and information on a menu applicable for a point award (or ingredients, prepared side dishes, and the like on special offer) as presentation information A1.

In the basic example, only mother 50 who owns terminal device 2A is given the selection authority to select the plurality of intermediate words B1. However, the context selection signal may also be transmitted to terminal device 2 of another user 5 in group G1, and the other user 5 may also be given the selection authority to select the plurality of intermediate words B1. Each terminal device 2 may also output a chat window in display screen 250 so that the members of group G1 can consult with each other about which intermediate words B1 and presentation information A1 to select with respect to the plurality of intermediate words B1 and presentation information A1 that are presented. In this case, information presenting system 100 can also provide a platform for family meetings pertaining to the cooking menu.

In the basic example, mother 50 was cook X1, but if another user 5 in group G1, e.g., father 53, temporarily acts as cook X1, he uses their own terminal device 2D to request a menu to be presented. In that case, information presenting system 100 basically allows terminal device 2D to perform the presentation of intermediate words B1 and presentation information A1.

In the basic example, mother 50, who acts as cook X1, requests menu recommendations from terminal device 2 while at home. For example, mother 50, who acts as cook X1, may request a menu recommendation from terminal device 2 while away from home (e.g., while shopping). In this case, it may be possible to set the user status pertaining to the current location of user 5 so as to greatly affect the determination of intermediate words B1.

In the basic example, information presenting system 100 determines and presents intermediate words B1 using the acceptance of a request for a menu recommendation from user 5 (mother 50) as a trigger. However, information presenting system 100 may, for example, automatically start the processing for determining intermediate words B1 at a predetermined time and notify (present) the user through a push notification or the like.

In the basic example, presentation information A1 included meal information pertaining to meals. Presentation information A1 may include information pertaining to music, books, videos, or the like instead of a meal.

### (4) Specific Example of Reference Example

A more specific example of the above-described reference example will be described hereinafter.

### (4.1) Configuration of Specific Example

The following will describe a specific example of a meal recommendation, which is a recommendation pertaining to a meal, as presentation information. Note that “meal recommendation” is a concept that includes presenting a menu or recipes constituted by a plurality of multiple menus, recommending meals that involve cooking, and recommending meals that do not involve cooking, such as eating out or eating prepared food. In the following descriptions, descriptions of configurations that can be regarded as substantially equivalent to the above-described reference example may be omitted here by using the same reference signs and referring to the foregoing descriptions.

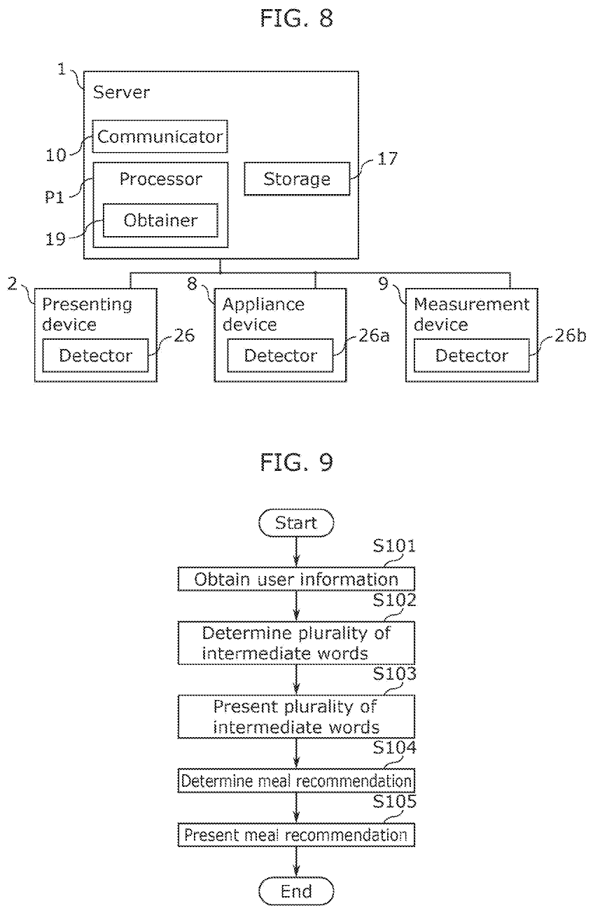

In the specific example described hereinafter, server 1a illustrated in FIG. 8 is used instead of server 1 in FIG. 1 above. FIG. 8 is a block diagram illustrating the functional configuration of a presenting system according to a specific example of the reference example. In FIG. 8, the configurations included in server 1 already described above are not illustrated, but server 1a will be described as having the same configuration as server 1 described above.

Specifically, server 1a differs from server 1 in that server 1a includes obtainer 19. Obtainer 19 is a processing unit for obtaining user information related to user 5, and is realized by executing a predetermined program using a processor and memory. For example, obtainer 19 is realized as a function of processor P1. Obtainer 19, for example, obtains information related to user 5 from detectors provided in various devices. Accordingly, obtainer 19 is communicatively connected to the detectors provided in various devices via, for example, communicator 10. The information obtained here will be described in detail below. The detectors from which obtainer 19 obtains the information may include detector 26 provided in terminal device 2, as well as detector 26a of appliance device 8 owned by user 5 and detector 26b of measurement device 9 owned by user 5. Obtainer 19 can also obtain user information from various external systems and the like. This configuration will also be described later.

As described above, in the present specific example, information presenting system 100 is information presenting system 100 that presents one meal recommendation among a plurality of meal recommendations to user 5. Accordingly, each intermediate word in the present specific example is a word associated with an attribute pertaining to one or more meal recommendations among the plurality of meal recommendations.

Information presenting system 100 in the present specific example operates as follows. FIG. 9 is a flowchart illustrating operations of the information presenting system according to a specific example of the reference example. As illustrated in FIG. 9, first, obtainer 19 obtains user information associated with user 5 (obtainment step S101). Next, first determiner 11 determines the condition information related to user 5 from the obtained user information and determines a plurality of intermediate words based on the condition information (first determining step S102). The condition information according to the present specific example will be described below, along with the user information.

Next, first presenter 13 presents the plurality of intermediate words to user 5 to enable user 5 to select at least one intermediate word from the plurality of intermediate words (first presenting step S103). Next, second determiner 12 determines a meal recommendation, corresponding to at least one intermediate word selected by user 5, from among the plurality of meal recommendations (second determining step S104). Next, second presenter 14 presents the determined meal recommendation to user 5 (second presenting step 105). Through this, there is an advantage in that it is easy to reflect a user's intentions in the meal recommendation while improving convenience for user 5.

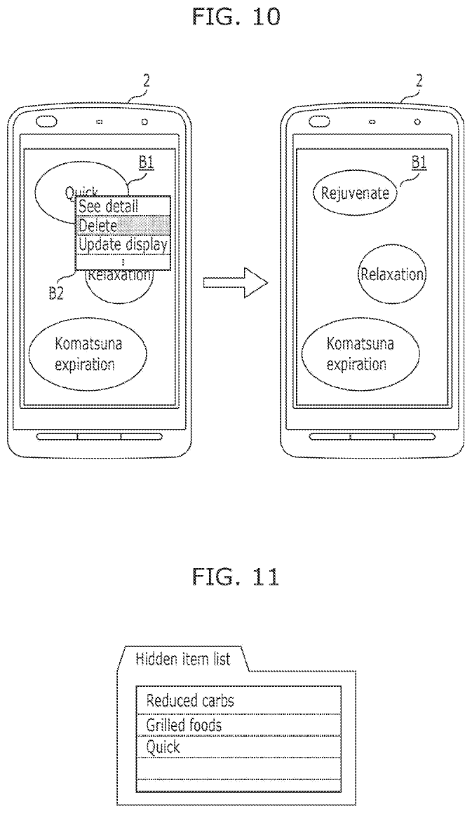

The intermediate words presented as described above can be deleted at the discretion of user 5. For example, FIG. 10 is a diagram illustrating an example of deleting an intermediate word according to a specific example of the reference example. In FIG. 10, intermediate word B1 before transmitting a deletion request is indicated on the left, and intermediate word B1 after transmitting the deletion request is indicated on the right. As illustrated in FIG. 10, once presented, whether to delete each intermediate word B1 can be requested individually by user 5. For example, user 5 long-presses display screen 250 on intermediate word B1 that they wish to delete. Sub-menu B2 for intermediate word B1 is then displayed. Intermediate word B1 selected by user 5 is deleted in response to “delete” being selected from sub-menu B2.

Here, “deletion” here includes both a temporarily non-presented state and a permanently non-presented state. For example, information such as “komatsuna expiration”, which has strong notification implications for the user, may be appropriate to be presented in the same manner when the user eventually buys more komatsuna, if the expiration date is approaching again. On the other hand, it preferable that presentations which reflect the behavioral characteristics and the like of user 5, such as “quick”, be permanently disabled if user 5 does not desire that presentation itself. Accordingly, in the present specific example, the configuration is such that the user can select whether to make a temporary non-presented state or a permanent non-presented state. Such a selection is made, for example, by user 5 selecting either “delete” or “permanently delete” (not shown) as desired.

Intermediate words B1 selected for permanent deletion are managed, for example, as illustrated in FIG. 11. FIG. 11 is a diagram illustrating an example of a hidden item list according to a specific example of the reference example. As illustrated in FIG. 11, intermediate words B1 selected for permanent deletion are registered in the hidden item list. Such a hidden item list is stored in storage 17 or the like and updated each time user 5 permanently deletes intermediate word B1.

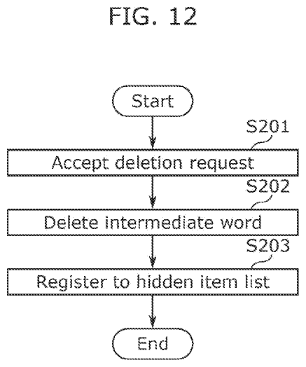

In deleting intermediate word B1, information presenting system 100 operates as follows. FIG. 12 is a flowchart illustrating operations pertaining to the deletion of an intermediate word according to a specific example of the reference example. As illustrated in FIG. 12, processor P1 first accepts the input of a deletion request from user 5 via inputter 24 or the like of terminal device 2 (first acceptance step S201). Upon accepting the deletion request, processor P1 changes the image presented in terminal device 2 and deletes the presentation of intermediate word B1 to be deleted from among the plurality of intermediate words B1 being presented (step S202). Furthermore, processor P1 determines whether this deletion request is for a temporary deletion or a permanent deletion (not shown), and if the deletion request is for a permanent deletion, registers intermediate word B1 to be deleted in the hidden item list (registration step S203).

Then, in first determining step S102, first determiner 11 determines to present a plurality of intermediate words based on the condition information and excluding the deleted intermediate words registered in the hidden item list. As a result, intermediate words B1 registered in the hidden item list are not be displayed in the subsequent processing. Note that intermediate word B1 registered in the hidden item list may be unregistered based on a separate operation made by user 5, so that the stated intermediate word B1 can be presented again.

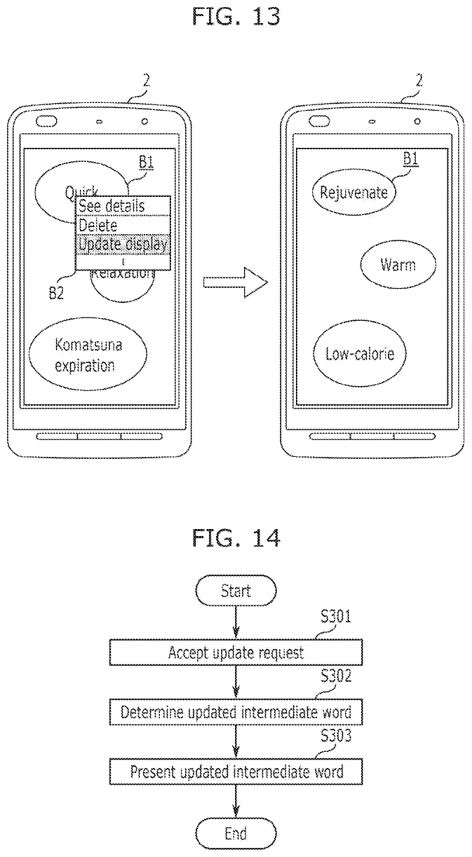

The display of intermediate words B1 presented as described above can be updated at the discretion of user 5. For example, FIG. 13 is a diagram illustrating an example of updating an intermediate word according to a specific example of the reference example. In FIG. 13, intermediate word B1 before transmitting an update request is indicated on the left, and intermediate word B1 after transmitting the update request is indicated on the right. As illustrated in FIG. 13, once intermediate word B1 is presented, user 5 can request that the displayed intermediate word B1 be updated if user 5 determines that there is no satisfactory intermediate word B1. For example, user 5 long-presses at any location on display screen 250 where intermediate word B1 is presented. Upon doing so, sub-menu B2 is displayed. By selecting “display update” from sub-menu B2, a new intermediate word B1 is presented in place of the presented intermediate word B1.

In updating intermediate word B1, information presenting system 100 operates as follows. FIG. 14 is a flowchart illustrating operations pertaining to the updating of an intermediate word according to a specific example of the reference example. As illustrated in FIG. 14, processor P1 first accepts the input of an update request from user 5 via inputter 24 or the like of terminal device 2 (second acceptance step S301). Upon receiving the deletion request, third determiner (not shown) included in processor P1 determines, based on the condition information, the updated intermediate words, which are a plurality of updated intermediate words B1 that are different from the plurality of intermediate words presented in first presenting step S102 (third determining step S302). Furthermore, third presenter (not shown) included in processor P1 presents a plurality of updated intermediate words to user 5 to enable user 5 to select one or more updated intermediate words (third presenting step S303).

The stated third determiner may be realized by first determiner 11. In this case, first determiner 11 is an example of the third determiner. The stated third presenter may be realized by first presenter 13. In this case, first presenter 13 is an example of the third presenter. When determining intermediate words B1, first determiner 11 determines, for example, a number of intermediate words B1 higher than the number to be presented, and of these, presents several according to predetermined criteria. If an update request is then accepted, a new intermediate word B1 that corresponds to the next point among the plurality of intermediate words B1 determined by first determiner 11 may be presented. This makes it possible to seamlessly present updated intermediate words without having to go through the process of determining a new intermediate word B1.

Trainer 18 described in the above reference example may also learn a trend in intermediate words B1 that are unnecessary to present to user 5 based on the deletion and display update of intermediate words B1 described above. The resulting trained model can be used to determine whether intermediate word B1 is an intermediate word that should be presented to user 5 for intermediate word candidates tentatively determined when first determiner 11 determines the intermediate words.

In addition to this, in the present specific example, of intermediate words B1 presented, intermediate word B1 selected more frequently can be presented in a manner that makes that intermediate word easier to select. Specifically, obtainer 19 further obtains a selection frequency, which is the frequency of selection of each of the plurality of intermediate words B1 presented in the past, and in first presenting step S103, presents the plurality of intermediate words B1 in accordance with the selection frequency, e.g., such that more emphasis is placed on words having a higher selection frequency. The “emphasis” may be, for example, increasing the size of the tags described above, using a different color from the other intermediate words B1, using a tag having a different shape from the other intermediate words B1, or the like. The “emphasis” here can be in any form that is more eye-catching to user 5 than the other intermediate words B1.

Furthermore, in the present specific example, information pertaining to the value of ingredients based on the scarcity or price of the ingredients held by user 5 is obtained, and intermediate words B1 are presented in a manner corresponding to the obtained value of the ingredients. Accordingly, obtainer 19 obtains information pertaining to the value of the ingredients held by user 5. For example, obtainer 19 may obtain the name and price of an ingredient purchased by user 5 through a website or the like, or may automatically collect information pertaining to scarcity using the name of the ingredient and generate a tag associated with the name of the ingredient. In addition, because the value of an ingredient has various aspects that are unique to user 5, the value may be calculated based on the preferences and the like of user 5 with respect to the ingredient, which are also present in advance.

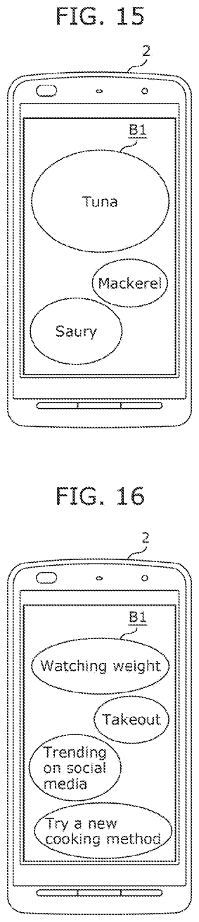

As a result of the above, in first presenting step S103, a plurality of intermediate words B1 can be presented in a manner dependent on the value of the ingredients. For example, FIG. 15 is a diagram illustrating an example of intermediate words presented in a manner dependent on the value of ingredients according to a specific example of the reference example. As illustrated in FIG. 15, intermediate words B1 indicating relatively expensive items, such as “tuna”, are presented with more emphasis than intermediate words B1 indicating relatively inexpensive items, such as “saury” and “mackerel”. More specifically, intermediate words B1 indicating relatively expensive items, such as “tuna”, are presented in a manner where the tag size is larger than that of other intermediate words B1. Here too, there is no particular limitation on the manner in which intermediate words B1 are presented as long as the words are presented in a manner that emphasizes ingredients having higher values.

### (4.2) Relationship Between User Information and Condition Information

A relationship between the user information and the condition information in the present specific example will be described hereinafter. For example, in the present specific example, as illustrated in FIG. 16, intermediate word B1 based on the obtained user information is presented. FIG. 16 is a diagram illustrating an example of intermediate words presented based on user information according to a specific example of the reference example. As illustrated in FIG. 16, intermediate words B1 presented in the present specific example can include those that improve the health of user 5 (“watching weight” in the drawing), those that match behavior estimated from the behavioral characteristics of user 5 (“trending on social media” in the drawing), those pertaining to meals that can be prepared within a time user 5 has available for cooking (“takeout” in the drawing), and those that promote improvement of the cooking abilities of user 5 (“try a new cooking method” in the drawing). Each will be described in detail below.

(4.2.1) Condition Information from Perspective of Health

First, user information pertaining to what improves the health of user 5 will be described. Here, the user information is obtained from an external schedule management system, measurement device 9, appliance device 8, or the like. The user information includes, for example, a schedule pertaining to the date and time user 5 will exercise. The user information also includes vital information and the like of user 5 obtained from stationary, portable, or implanted devices such as blood pressure monitors, blood sugar meters, toilets, scales, activity meters, thermometers, and the like, which are examples of measurement device 9. The user information also includes information pertaining to a time difference between sleeping and waking, or a lack of sleep based on the quality of sleep, obtained from devices such as bedding, lighting, air conditioning devices, and the like, which are examples of appliance device 8. The user information also includes information pertaining to a date and time and location information obtained from a device such as a time measurement device, which is an example of terminal device 2 or appliance device 8.

For example, as the condition information determined from the above-described user information, a nutritional intake goal and the like are set according to the health of user 5, the exercise being performed, and the like. An intermediate word is then determined for this set nutritional intake. For example, if user 5 exercises often, it is assumed that user 5 wishes to increase muscle strength as the condition information, and thus intermediate words B1 such as “efficiently increase muscle strength” are presented, and a relatively high-protein meal recommendation is made. Additionally, for example, if user 5 seldom exercises, it is assumed that user 5 wishes to suppress weight gain as the condition information, and thus intermediate words B1 such as “watching weight” are presented, and a low-calorie meal recommendation is made. Similarly, when a meal is eaten late at night, intermediate words B1 such as “watching weight” are presented, and a low-calorie meal recommendation is also made.

For example, if the intestinal environment is detected as being poor from the state of excrement from user 5, it is assumed that user 5 is aiming to normalize their intestinal environment as the condition information, and thus intermediate words B1 such as “improve stomach condition” are presented, and a meal recommendation with adjusted prebiotics and probiotics is made. Additionally, for example, if a state such as menstruation or pregnancy is detected from the state of the excrement of user 5, it is assumed that user 5 desires dietary support for the period of menstruation or pregnancy as the condition information, and thus intermediate words B1 such as “menstruation or pregnancy support” are presented, and a meal recommendation that can supplement micronutrients which are often lacking, such as iron or folic acid, is made.

For example, if a condition such as abnormal urinary sugar is detected from the state of excrement of user 5, it is assumed that user 5 wishes to improve diabetes or the like as the condition information, and thus intermediate words B1 such as “watching blood sugar level” is presented, and a meal recommendation for moderating a rise in blood sugar level is made. In conjunction with this meal recommendation, a way of eating that moderates the rise in blood sugar level may also be presented. Additionally, for example, if a condition such as hypertension is detected from the state of the blood pressure value of user 5, it is assumed that user 5 wishes to improve hypertension or the like as the condition information, and thus intermediate words B1 such as “watching blood pressure” is presented, and a meal recommendation with reduced salt content is made.

Additionally, for example, if a condition such as high fatigue is detected from a state such as the amount of activity of user 5, it is assumed that user 5 wishes to recover from fatigue as the condition information, and thus intermediate words B1 such as “recover from fatigue for tomorrow” is presented, and a meal recommendation having a good balance of vitamins or the like is made.

Additionally, for example, a reduction of the cooking load, a relaxation effect of the meal being achieved, and the like are set, according to information such as the stress level, lack of sleep, and the like of user 5, as the condition information determined from the above-described user information. An intermediate word is then determined for the cooking load and relaxation effect that have been set. For example, if a condition such as an excessive amount of activity and a lack of sleep are detected in user 5, it is assumed that user 5 wishes to reduce the cooking load and to obtain a relaxation effect through the meal as the condition information, and thus intermediate words B1 such as “rest and refresh” are presented, and a meal recommendation that requires less cooking time or uses a home delivery service, and that is expected to have a relaxation effect, is made.

In this manner, in the present specific example, the user information is information pertaining to the health of user 5, and the condition information may include information pertaining to conditions that improve the health of user 5.

(4.2.2) Condition Information from Perspective of Behavioral Characteristics

The user information pertaining to items that match behavior estimated from the behavioral characteristics of user 5 will be described next. Here, the user information is obtained from a web server, appliance device 8, an external schedule management system, a sensor device, or the like. The user information includes, for example, information that user 5 has come into contact with via a website or the like and that has a positive sentiment (e.g., information in a favorite or positive comment written on a social network service (SNS)). The user information also includes, for example, information that the user has come into contact with through information appliances such as televisions (based on channel information, program information, and the like). For example, a genre of relevant meal recommendations or the like, based on subjects of interest to user 5, is set as the condition information determined from the above-described user information. For example, if a specific region is detected as an object of interest to user 5, it is assumed that user 5 desires a dining experience pertaining to a specific region as the condition information, and thus intermediate words B1 such as “local cuisine” are presented, and a meal recommendation such as traditional cuisine of the specific region is made. Additionally, for example, if a predetermined dish is detected as an object of interest to user 5, it is assumed that user 5 desires a dining experience similar to the predetermined dish as the condition information, and thus intermediate words B1 such as “food genre: A” are presented, and a meal recommendation for dishes in the genre to which the predetermined dish belongs is made.

On the other hand, for example, if a subject is of interest to user 5 but has already been experienced by user 5 or if a sufficient period of time has not elapsed since the previous experience, a setting is made so as to avoid the genre of meal recommendations related to that subject as the condition information determined from the above-described user information.

The user information also includes, for example, a schedule of unusual experiences that user 5 may have, such as events and the like. In such a case, a genre of relevant meal recommendations or the like, based on events in which user 5 participates, is set as the condition information determined from the above-described user information. For example, if an event in which user 5 participates, such as the Girls' Day or Day of the Ox, is detected, it is assumed that user 5 wishes to experience a meal pertaining to the event as the condition information, and thus intermediate words B1 such as “Girls' Day dishes” are presented, and a meal recommendation such as dishes associated with the event is made.

The user information also includes information about the climate, which may help user 5 narrow down meal candidates, such as temperature differences, for example. For example, if a temperature difference of 5 degrees C. or more is detected, it is assumed that user 5 desires a warm or cold meal experience as the condition information, and thus intermediate words B1 such as “warm food” is presented, and a meal recommendation such as warm food is made.

User information also includes, for example, information on the time and location at which available ingredients are determined. For example, if the current time and the location of user 5 are detected, it is assumed, as the condition information, that the user wishes to have a meal using ingredients that are available at a store that can be reached before the store closes from the current location of user 5 and that are as inexpensive as possible, and thus intermediate words B1 such as “buy ingredients now” are presents, and a meal recommendation such as dishes which can be prepared using such available ingredients is made. In addition, information on stores to stop by may also be presented at this time.

In addition, a schedule, such as an anniversary date, may simply be obtained as user information. For example, if a schedule such as an anniversary date is detected, it is assumed that user 5 wishes to have a meal experience associated with the anniversary as the condition information, and thus intermediate words B1 such as “wedding anniversary” are presented, and a meal recommendation is made based on dishes had on past wedding anniversaries.

Information such as the availability of favorite ingredients may also be obtained as the user information. For example, if a favorite ingredient is learned and the obtainment of the favorite ingredient is detected, it is assumed that user 5 desires a meal using the favorite food ingredient as the condition information, and thus intermediate words B1 such as “lamb dishes” is presented, and a meal recommendation using lamb is made. Additionally, for example, if a favorite ingredient is learned and it is detected that a meal using that favorite ingredient has not been had for some time, it is assumed that user 5 desires a meal using the favorite food ingredient as the condition information, and thus intermediate words B1 such as “lamb dishes” may be presented, and a meal recommendation using lamb may be made.

Additionally, for example, when a plurality of diners are assumed, such as a family constituted by a plurality of members, which of the diners will be the focus around whom the condition information is to be set may be estimated based on past meal recommendation selection trends and the like. For example, for user 5 who has selected a relatively large number of meal recommendations flagged for children, the user information to be obtained may be obtained from family members of the user who are children. On the other hand, for example, for user 5 who has selected a relatively large number of meal recommendations flagged for adults, the user information to be obtained may be obtained from family members of the user who are adults.

The user information also includes, for example, information pertaining to a cooking cycle of user 5. For example, if a tendency to have a relatively large amount of cooking time on the first and third days out of seven consecutive days is obtained, it is assumed that user 5 wishes to cook all the food on the first and third days as the condition information, and thus intermediate words B1 such as “cook in bulk” are presented on the first and third days, and a meal recommendation such as a dish that can be made in advance is made. On the other hand, on the second and fourth through seventh days, intermediate words B1 such as “quick” are presented, and a meal recommendation centered on consuming dishes that have been prepared in advance is made.

The user information also includes, for example, information pertaining to a cooking tendency of user 5. For example, when information pertaining to a cooking tendency such as the tendency to use cooking equipment more frequently, such as using the microwave or grill more frequently, making more fried food, or cooking more one-plate meals is learned, and when it is detected that ingredients which match those tendencies have been obtained, intermediate words B1 such as “the usual” are presented, and a meal recommendation such as a dish that matches the stated cooking tendency is made.

In this manner, in the present specific example, the user information is information pertaining to the behavioral characteristics of user 5, and the condition information may include information pertaining to conditions that match behavior estimated from the behavioral characteristics of user 5.

(4.2.3) Condition Information from Perspective of Available Cooking Time

User information pertaining to meals that can be prepared within the available cooking time of user 5 will be described next. Here, the user information is obtained from an external schedule management system, appliance device 8, a sensor device, or the like. The user information includes, for example, a schedule pertaining to times user 5 cannot use for cooking. The user information also includes information such as an operating status obtained from devices such as washing machines, vacuum cleaners, dishwashers, and the like, which are examples of appliance device 8. The user information includes information pertaining to an activity status of user 5 obtained from devices such as cameras, microphones, thermal image sensors, and the like, which are examples of sensor devices, as well as a remaining amount of housework, which is the amount of housework that has not been performed. The user information may also include information pertaining to the busyness of user 5 determined by machine learning or the like based on the number of times a dedicated app runs, the timing at which push notifications are tapped, and the like obtained from terminal device 2.

For example the cooking time which can be prepared within the available cooking time, based on the amount of time user 5 cannot use for cooking, an operating status, an activity status, and the remaining amount of housework, can be set as the condition information determined from the above-described user information. Intermediate words are then determined for this set cooking time. For example, if there is a dish that can be cooked within the available cooking time for user 5, and if user 5 has ingredients with which the dish can be cooked, it is assumed that user 5 wishes to cook the dish using the ingredients as the condition information, and thus intermediate words B1 such as “can be cooked in the remaining time” are presented, and a meal recommendation to cook the stated dish is made.

Additionally, for example, if there is no dish that can be cooked within the available cooking time for user 5, it is assumed that user 5 does not want to cook the dish as the condition information, and thus intermediate words B1 such as “eating out” or “eating prepared food” are presented, and stores where eating out or eating prepared food are available nearby are presented based on the location information of user 5.

A recommendation in which the sum of the cooking time, eating time, and cleanup time falls within the above-described available cooking time may be made as a meal recommendation presented through the foregoing processing. For example, a meal recommendation may be made that meets a child's preferences so that it does not take the child long to eat, or a one-bowl meal may be recommended that uses fewer dishes. If the eating time is below a predetermined threshold, meal recommendations may be made with dishes that are relatively easy to digest.

On the other hand, if a relatively long available cooking time can be provided, intermediate words B1 such as “food education” or “make in advance” may be presented as well as a presentation that makes effective use of the available cooking time of user 5. At the same time, points for helping with food education may also be presented.

In this manner, in the present specific example, the user information is information pertaining to the available cooking time for user 5 to cook a meal, and the condition information may include information pertaining to the conditions under which the meal can be prepared within the available cooking time for user 5.

(4.2.4) Condition Information from Perspective of Cooking Abilities

User information pertaining to what facilitates an improvement in the cooking abilities of user 5 will be described next. Here, the user information is obtained from storage 17 or the like. The user information includes, for example, information on a cooking history pertaining to a history of cooking performed by user 5 in the past.

For example, promoting the improvement of the cooking abilities of user 5 is set as the condition information determined from the above-described user information. Intermediate words are then determined according to the set improvement in the cooking abilities. For example, if it is detected from the cooking history of user 5 that a certain level of cooking has been performed a predetermined number of times, it is assumed, as the condition information, that user 5 desires the presentation of a dish that involves cooking at a higher level than the certain level, and thus intermediate words B1 such as “cooking level up” are presented, and a meal recommendation to cook the stated dish is made. Additionally, for example, when it is detected from the cooking history of user 5 that a certain level of cooking has been performed a predetermined number of times, it is assumed that user 5 desires a reward for cooking as the condition information, and thus intermediate words B1 such as “reward for hard work” are presented, and furthermore, a coupon is issued and a meal recommendation is made for a meal out or the like to which the coupon can be applied.

In this manner, in the present specific example, the user information is information pertaining to the cooking abilities of user 5 when cooking meals, and the condition information may include information pertaining to conditions that promote improvements in the cooking abilities of user 5.

### (5) Conclusion

As described above, an information presenting method according to a first aspect is an information presenting method for presenting a piece of presentation information (A1) among a plurality of pieces of presentation information (A1) to a user (5). The information presenting method includes a first determining step, a first presenting step, a second determining step, and a second presenting step. In the first determining step, a plurality of intermediate words (B1) are determined based on condition information (C1) related to the user (5). In the first presenting step, the plurality of intermediate words (B1) are presented to the user (5) to enable the user (5) to select at least one intermediate word (B1) from the plurality of intermediate words (B1). In the second determining step, presentation information (A1) corresponding to at least one intermediate word (B1) selected by the user (5) is determined from among the plurality of pieces of presentation information (A1). In the second presenting step, the determined presentation information (A1) is presented to the user (5). Each of the plurality of intermediate words (B1) is a word associated with an attribute (D1) related to at least one of the plurality of pieces of presentation information (A1). According to the first aspect, it is easier to reflect the intentions of the user (5) while improving convenience for the user (5).

With respect to an information presenting method according to a second aspect, in the first aspect, the condition information (C1) includes historical information. According to the second aspect, it is easier to reflect the lifestyle patterns, preferences, and the like of the user (5) in the plurality of intermediate words (B1), and as a result, it is easier to present presentation information (A1) that better reflects the intentions of the user (5).

With respect to an information presenting method according to a third aspect, in the second aspect, the historical information includes a history pertaining to the plurality of intermediate words (B1) presented to the user (5) in the first presenting step in the past. According to the third aspect, the lifestyle patterns, preferences, and the like of the user (5) are more easily reflected in the plurality of intermediate words (B1).

With respect to an information presenting method according to a fourth aspect, in the second or third aspect, the historical information includes a history pertaining to one or more intermediate words (B1) presented to the user (5) in the past. According to the fourth aspect, the lifestyle patterns, preferences, and the like of the user (5) are more easily reflected in the plurality of intermediate words (B1).

With respect to an information presenting method according to a fifth aspect, in any one of the second to fourth aspects, the historical information includes a history pertaining to behavior of the user (5) who received the presentation of the presentation information (A1) in the second presenting step in the past. According to the fifth aspect, the lifestyle patterns, preferences, and the like of the user (5) are more easily reflected in the plurality of intermediate words (B1).

With respect to an information presenting method according to a sixth aspect, in any one of the first to fifth aspects, the presentation information (A1) includes meal information pertaining to a meal. According to the sixth aspect, a recommendation pertaining to a meal can be made which makes it easier to reflect the intentions of the user (5) while improving convenience for the user (5).

With respect to an information presenting method according to a seventh aspect, in the sixth aspect, the meal information includes information pertaining to a cooking menu. According to the seventh aspect, a recommendation pertaining to a cooking menu can be made which makes it easier to reflect the intentions of the user (5) while improving convenience for the user (5).

With respect to an information presenting method according to an eighth aspect, in the sixth or seventh aspect, at least one of the first determining step and the second determining step includes a determination based at least on a management date pertaining to an ingredient. According to the eighth aspect, a recommendation pertaining to a meal can be made which also takes into account a management date pertaining to an ingredient.

With respect to an information presenting method according to a ninth aspect, in the eighth aspect, at least one of the first determining step and the second determining step includes a determination based on a management date and a lifestyle pattern of the user (5). According to the ninth aspect, in addition to the management date pertaining to ingredients, recommendations regarding meals can be made taking into account the lifestyle patterns of user (5).

An information presenting method according to a tenth aspect further includes, in any one of the sixth to ninth aspects, a third presenting step of presenting a preservation method for a specific ingredient when the user (5) exhibits behavior that negates consumption of the specific ingredient. According to the tenth aspect, the convenience can be further improved.

With respect to an information presenting method according to an eleventh aspect, in any one of the sixth to tenth aspects, in the second presenting step, an ingredient list corresponding to each of two or more meals is presented in a batch as the presentation information (A1). The ingredient list is updated in response to changes in the condition information (C1). According to the eleventh aspect, for example, when condition information C1 can change on a daily basis, the ingredient list can be presented in a form that reflects the changes.

With respect to an information presenting method according to a twelfth aspect, in any one of the sixth to eleventh aspects, in the second presenting step, an ingredient list corresponding to each of two or more meals is presented in a batch as the presentation information (A1). The ingredient list is updated according to the results of selections made by the user (5) when the presentation information (A1) was presented in the past. According to the twelfth aspect, the ingredient list can be presented in a form that better reflects the lifestyle patterns, preferences, and the like of the user (5).

An information presenting method according to a thirteenth aspect further includes, in any one of the first to twelfth aspects, a setting step of setting a group (G1) including a plurality of users (5). At least one of the first presenting step and the second presenting step performs the presentation at the level of the group (G1). According to the thirteenth aspect, an information presenting method for a plurality of users (5) (e.g., for family members) can be provided.

With respect to an information presenting method according to a fourteenth aspect, in the thirteenth aspect, the authority to select presentation information (A1) presented in the second presenting step is given only to a predetermined user (5) in the group (G1). According to the fourteenth aspect, when an executor who executes a specific action based on the presented presentation information (A1 (e.g., a cook) and a non-executor who does not execute the action are mixed in the group (G1), the convenience can be improved by providing the authority only to the executor.

With respect to an information presenting method according to a fifteenth aspect, in the thirteenth or fourteenth aspect, a plurality of the users (5) in the group (G1) are assigned a priority level. In the first determining step, a plurality of intermediate words (B1) are determined based on condition information (C1) related to the user (5) having the highest priority level. According to the fifteenth aspect, condition information (C1) associated with the user (5) having the highest priority level is more easily reflected in the plurality of intermediate words (B1).

A program according to a sixteenth aspect is a program for causing one or more processors to execute the information presenting method according to any one of the first through fifteenth aspects. According to the thirteenth aspect, a function can be provided that makes it easier to reflect the intentions of the user (5) while improving convenience for the user (5).

An information presenting system (100) according to a seventeenth aspect presents one piece of presentation information (A1) to a user (5) from among a plurality of pieces of presentation information (A1). The information presenting system (100) includes a first determiner (11), a first presenter (13), a second determiner (12), and a second presenter (14). The first determiner (11) determines a plurality of intermediate words (B1) based on condition information (C1) related to the user (5). The first presenter (13) presents the plurality of intermediate words (B1) to the user (5) to enable the user (5) to select at least one intermediate word (B1) from the plurality of intermediate words (B1). The second determiner (12) determines presentation information (A1), corresponding to at least one intermediate word (B1) selected by user (5), from among the plurality of pieces of presentation information (A1). The second presenter (14) presents the determined presentation information (A1) to the user (5). Each of the plurality of intermediate words (B1) is a word associated with an attribute (D1) related to at least one of the plurality of pieces of presentation information (A1). According to the seventeenth aspect, an information presenting system (100) can be provided that makes it easier to reflect the intentions of the user (5) while improving convenience for the user (5).

The configurations according to the second through fifteenth modes are not essential to the information presenting method and can be omitted as appropriate.

### Embodiment

### (1) Configuration

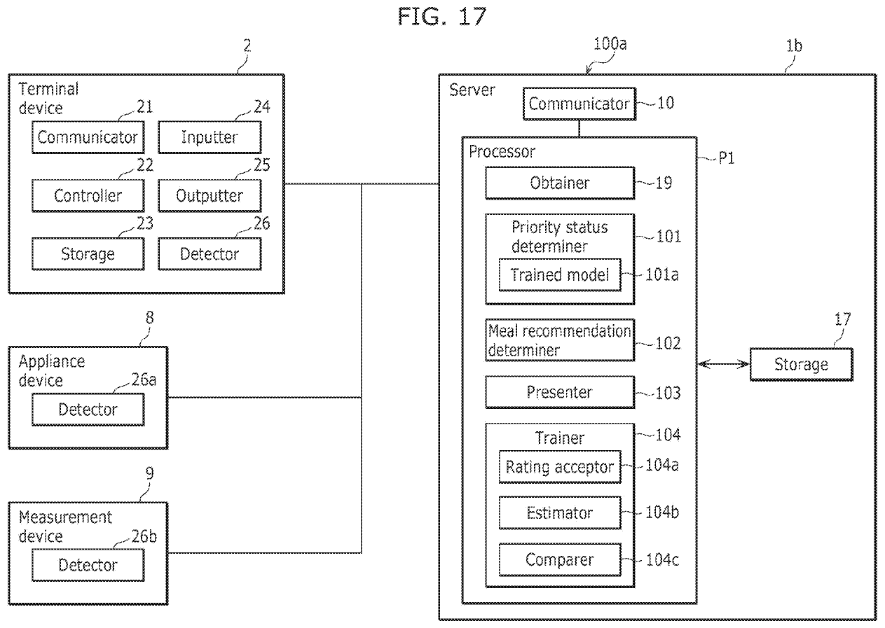

The configuration of information presenting system 100a according to an embodiment will be described in detail below with reference to FIG. 17. FIG. 17 is a diagram illustrating the overall configuration of information presenting system 100a and terminal device 2 according to the embodiment. In the embodiment described below, points that are the same as in the above reference example and specific examples will not be described. Information presenting system 100a according to the embodiment is constituted by server 1b illustrated in FIG. 17 instead of the above-described server 1a illustrated in FIG. 8. Note that in the embodiment, information presenting system 100a may include devices such as terminal device 2, appliance device 8, measurement device 9, or the like.

Server 1b includes communicator 10, processor P1, and storage 17. Processor P1 includes obtainer 19, priority status determiner 101, meal recommendation determiner 102, presenter 103, and trainer 104. Communicator 10 and storage 17 need not be included in the constituent elements of information presenting system 100a according to the embodiment. Additionally, trainer 104 of processor P1 need not be included in the constituent elements of information presenting system 100a according to the embodiment.

As described in the reference example above, communicator 10 is a communication interface for bidirectional communication with terminal device 2 of each user 5 and cooking appliances such as range device 4 (see FIG. 1) via network NT1 (see FIG. 1). Communicator 10 is configured to be capable of communicating with detector 26 provided in terminal device 2, detector 26a of appliance device 8 owned by user 5, detector 26b of measurement device 9 owned by user 5, and the like, as described in the foregoing specific examples.

Obtainer 19 obtains user information related to user 5 from detectors provided in various devices and/or various external systems (for example, a schedule management system or the like) via communicator 10 or the like, as described in the foregoing specific examples. Obtainer 19 is the entity that executes obtaining step ST1 of an information presenting method according to the embodiment. The specific details of the user information obtained by obtainer 19 have already been described in the foregoing reference example and specific examples, and will therefore not be described here.

Priority status determiner 101 determines a priority status (priority context conditions) that user 5 is assumed to prioritize among a plurality of statuses (context conditions) related to user 5 based on the user information obtained by obtainer 19 (obtaining step ST1). Priority status determiner 101 is the entity that executes priority status determining step ST2 of the information presenting method according to the embodiment. In other words, instead of having user 5 select intermediate word B1 as in the foregoing reference example and specific examples, priority status determiner 101 executes processing corresponding to automatically determining a status (context conditions) corresponding to intermediate word B1 that user 5 is assumed to select.

Specifically, priority status determiner 101 extracts a plurality of context conditions using the user information obtained by obtainer 19. For example, if the user information includes time information, context conditions such as “after 7:00 PM” and/or “weekends and holidays” are extracted. Additionally, for example, if the user information includes health information, context conditions such as “higher than standard BMI” and/or “higher than standard blood sugar level” are extracted.

Priority status determiner 101 then determines one or more priority context conditions that user 5 is assumed to prioritize from the extracted plurality of context conditions. In other words, priority status determiner 101 (in priority status determining step ST2) determines a status having a priority rank that is at least a predetermined rank among a plurality of statuses (context conditions) as the priority status (priority context conditions). For example, if the predetermined rank is set to 1, priority status determiner 101 then determines one priority context condition that user 5 is assumed to prioritize the most from the plurality of context conditions. Additionally, for example, if the predetermined rank is set to 3, priority status determiner 101 then determines the highest three priority context conditions that user 5 is assumed to prioritize from the plurality of context conditions.

As an example, assume that, based on the user information obtained by obtainer 19, priority status determiner 101 extracts the context conditions of “after 7:00 PM”, “outside the home”, “higher than standard BMI”, “ingredient having expiration date within one day present”, and “at least 4 degrees lower than the previous day's temperature”. In this case, for example, from these five context conditions, priority status determiner 101 determines two context conditions as priority context conditions, namely “after 7:00 PM” and “ingredient having expiration date within one day present”.

The process by which the priority context conditions are determined by priority status determiner 101 can vary for each user 5. In other words, depending on user 5, priority status determiner 101 can determine “higher than standard BMI” as a priority context condition from the foregoing five context conditions. In other words, priority status determiner 101 determines the priority context conditions for each user 5, rather than uniformly determining the same priority context conditions for all users 5.

In the embodiment, priority status determiner 101 (in priority status determining step ST2) uses trained model 101a trained through machine learning to determine the priority status from the user information. Trained model 101a is configured as a neural network having a multilayer structure, for example, and is a model in which machine learning has been completed such that when a plurality of context conditions extracted from the user information are input, one or more priority context conditions are output. For example, trained model 101a is a model trained through unsupervised machine learning, and is generated for each user 5. Specifically, trained model 101a is generated for each user 5 based on the user information history accumulated on a daily basis, by analyzing the structure and features of the history of the user information, performing clustering, and the like.

Note that priority status determiner 101 may determine the priority status on a rule basis without using trained model 101a. For example, priority status determiner 101 may read out data for determining the priority status, stored in advance in storage 17, and determine the priority status corresponding to the user information obtained by obtainer 19 by referring to that data. The data for determining the priority status is data that is stored in storage 17 in advance for each user 5, and the user information and the priority status are associated with each other on a “many-to-many” basis. The data for determining the priority status is generated, for example, based on the results of a questionnaire about meal recommendations given to user 5 prior to the start of the use of information presenting system 100a and/or the history of the user information accumulated on a daily basis.

Ideally, priority status determiner 101 is preferably in a state of high accuracy in determining the priority status appropriate for user 5 from the time information presenting system 100a starts being used, but is not limited thereto. For example, priority status determiner 101 may use a generic model (i.e., a model that has not been trained specifically for user 5) as trained model 101a to determine the priority status at the start of use of information presenting system 100a. In this case, priority status determiner 101 can continue to determine a priority status not suitable for user 5 for some time after information presenting system 100a starts being used, but by repeatedly re-training trained model 101a in response to ratings from user 5 as will be described later, priority status determiner 101 can become highly accurate in determining a priority status suited to user 5.

Meal recommendation determiner 102 determines a meal recommendation in the same manner as second determiner 12 in the foregoing reference example and specific examples. On the other hand, meal recommendation determiner 102 determines a meal recommendation corresponding to the priority status determined by priority status determiner 101 (priority status determining step ST2, as opposed to intermediate word B1. Meal recommendation determiner 102 corresponds to meal recommendation determining step ST3 of the information presenting method according to the embodiment. In other words, instead of determining a meal recommendation corresponding to one or more intermediate words B1 selected by user 5 as in the foregoing reference example and specific examples, meal recommendation determiner 102 executes processing corresponding to determining a meal recommendation corresponding to one or more intermediate words B1 estimated to be selected by user 5. Specifically, meal recommendation determiner 102 reads out data for determining a meal recommendation stored in advance in storage 17 and determines a meal recommendation corresponding to the priority status determined by priority status determiner 101 by referring to that data. The data for determining the meal recommendation is data that is stored in advance for each user 5, and the priority status and the meal recommendation are associated with each other on a “many-to-many” basis.

Presenter 103 presents the determined meal recommendation to user 5 in the same manner as second presenter 14 in the foregoing reference example and specific examples. In other words, presenter 103 presents the meal recommendation determined by meal recommendation determiner 102 (meal recommendation determining step ST3) to user 5. Presenter 103 is the entity that executes presenting step ST4 of the information presenting method according to the embodiment. Specifically, presenter 103 generates a menu presentation signal that includes the meal recommendation determined by meal recommendation determiner 102, and transmits the generated menu presentation signal to terminal device 2 via communicator 10. As a result, the meal recommendation included in the menu presentation signal is displayed in display screen 250 of display 25A of terminal device 2 that received the menu presentation signal.

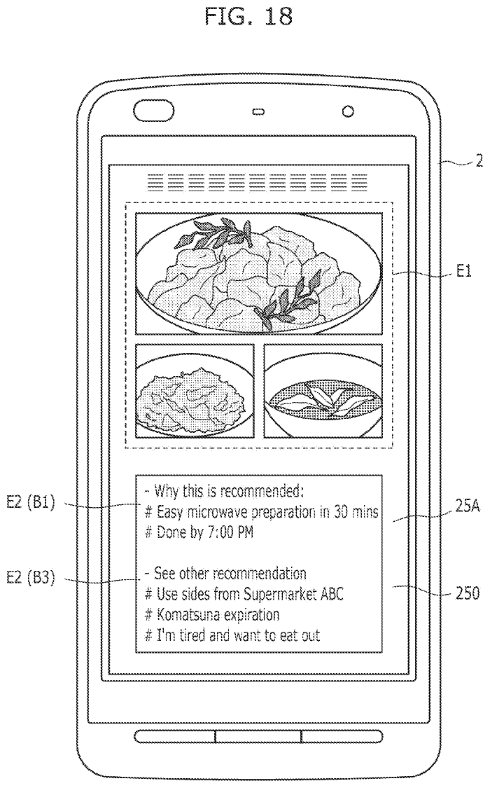

An example of the information presented to user 5 by presenter 103 will be described here with reference to FIG. 18. FIG. 18 is a diagram illustrating an example of a meal recommendation and intermediate words B1 displayed in terminal device 2 according to the embodiment. In the example illustrated in FIG. 18, image E1, which includes the names of three dishes and the appearance of each dish, is displayed as a meal recommendation in display screen 250 of display 25A of terminal device 2. The three dishes include a main dish and side dishes. In the example illustrated in FIG. 18, in addition to the meal recommendation, intermediate word B1 is displayed on display screen 250 alongside image E1 as “why this is recommended” for the meal recommendation. In other words, in the embodiment, presenter 103 (presenting step ST4) further presents, to the user (5), intermediate words B1 corresponding to an attribute pertaining to the meal recommendation determined by meal recommendation determiner 102 (meal recommendation determining step ST3).

There may be one or a plurality of intermediate words B1. Additionally, intermediate words B1 may be presented as a character string representing intermediate words B1 themselves, or as a sentence containing intermediate words B1. In the example illustrated in FIG. 18, sentence E2 containing intermediate words B1 is displayed in display screen 250 in the form of “#easy microwave preparation in 30 mins” and “#done by 7:00 PM”.

Furthermore, in the example illustrated in FIG. 18, in addition to the meal recommendation and intermediate words B1, other intermediate words B3, which are different from intermediate words B1, are displayed in display screen 250 alongside image E1 and intermediate words B1. In other words, in the embodiment, presenter 103 (presenting step ST4) further presents, to user 5, other intermediate words B3 corresponding to an attribute pertaining to another meal recommendation different from the meal recommendation determined by meal recommendation determiner 102 (meal recommendation determining step ST3). Specifically, sentence E3 containing the other intermediate words B3 is displayed in display screen 250 in the form of “#use sides from supermarket ABC”, “#komatsuna expiration”, and “#I'm tired and want to eat out”, under a title “see other recommendations”. The other intermediate words B3 are intermediate words corresponding to a status (context conditions) positioned lower than a predetermined rank by priority status determiner 101, for example.

For example, assume that user 5 has tapped another intermediate word B3 on display screen 250 with their fingertip or the like. In this case, a signal indicating that an input selecting the other intermediate word B3 is transmitted from terminal device 2 to information presenting system 100a. When communicator 10 receives this signal, meal recommendation determiner 102 re-determines the meal recommendation corresponding to the other intermediate word B3 selected by user 5. Presenter 103 then presents the meal recommendation re-determined by meal recommendation determiner 102 to user 5. In this manner, user 5 can request another meal recommendation if they are not willing to use the meal recommendation presented by presenter 103. Note that when the user swipes left, right, up, or down on display screen 250 with a fingertip or the like, the meal recommendations corresponding to the other intermediate words B3 may be displayed in display screen 250 with each swipe operation according to the order in which the other intermediate words B3 are listed in display screen 250.

Trainer 104 has a function for updating the process through which the priority status is determined by priority status determiner 101 (priority status determining step ST2). Trainer 104 is the entity that executes updating step ST6 of the information presenting method according to the embodiment. In the embodiment, the process for determining the priority status by priority status determiner 101 is executed by trained model 101a. Accordingly, in the embodiment, trainer 104 updates the process for determining the priority status, performed by priority status determiner 101, by re-training trained model 101a. Trainer 104 includes rating acceptor 104a, estimator 104b, and comparer 104c.

Rating acceptor 104a accepts a rating, by user 5, of the meal recommendation presented by presenter 103 (presenting step ST4). Rating acceptor 104a is the entity that executes rating accepting step ST5 of the information presenting method according to the embodiment. Specifically, when user 5 inputs a rating for the meal recommendation in terminal device 2, a rating signal including that rating is transmitted from terminal device 2 to communicator 10 of server 1b. Rating acceptor 104a accepts the rating by obtaining the rating included in rating signal when the rating signal is received by communicator 10. Note that the rating signal may be transmitted from terminal device 2 to communicator 10 of server 1b at the point in time when user 5 inputs the rating, or, after user 5 inputs ratings over a number of days and then makes an operational input instructing the ratings to be transmitted in a batch, the ratings may be transmitted from terminal device 2 to communicator 10 of server 1b in a batch at that point in time.

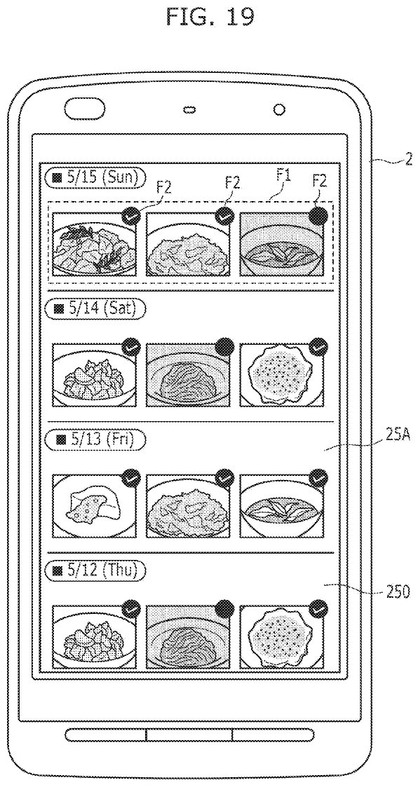

An example of a rating for a meal recommendation by user 5 will be described here with reference to FIG. 19. FIG. 19 is a diagram illustrating an example of a rating of a meal recommendation by user 5 in terminal device 2 according to the embodiment. In the example illustrated in FIG. 19, meal recommendations presented to user 5 on each of a plurality of days (here, four days, from May 12 to May 15) are displayed as images F1 in display screen 250 of display 25A of terminal device 2. Here, each image F1 is an image showing the appearance of three dishes as the meal recommendation. In addition, check box F2 is displayed at the upper-right edge of each image showing the appearance of the dish.

When user 5 has eaten a dish for which a meal recommendation has been mad, they tap check box F2 with a fingertip or the like. As a result, a checkmark is placed in check box F2, which means that user 5 has input a rating indicating that the dish has been eaten. On the other hand, if user 5 has not eaten a dish for which a meal recommendation, they do not tap check box F2. In this case, a rating by user 5, indicating that they did not eat the dish, is input in an indirect manner.

Although not illustrated in FIG. 19, if user 5 has eaten another dish aside from the dishes for which meal recommendations have been made, they can also input a rating indicating that the stated dish was eaten (i.e., that a change was made from the dish in the meal recommendation to another dish). For example, user 5 can input a rating by uploading an image taken of the other dish. Additionally, for example, user 5 can also input a rating by selecting the other dish from a list in which a plurality of dishes are listed. Additionally, for example, user 5 can also input a rating by inputting a character string indicating the features of the other dish (e.g., the name of the dish, the name of the place where the dish is served (a restaurant or the like), the ingredients, and/or the calories). Additionally, for example, user 5 can also input a rating indicating that the dish for which the meal recommendation was made was cooked or not cooked.

Based on the rating accepted by rating acceptor 104a, estimator 104b estimates the status (context conditions) of the dish actually eaten by user 5, i.e., the actual priority status (priority context conditions) of user 5. For example, when user 5 inputs a rating indicating that the dish in the meal recommendation was eaten, estimator 104b estimates the priority status determined by priority status determiner 101 as the actual priority status of user 5. Additionally, for example, when user 5 inputs a rating indicating that the dish in the meal recommendation was not eaten, estimator 104b reads out data for estimation, stored in storage 17 in advance, and estimates the actual priority status of user 5 by referring to that data.

The data for estimation is data stored for each user 5 in advance, in which data of a dish (for example, the name of the dish or the like) is associated with a status (context conditions). As an example, in the data for estimation, “meal A” is associated with context conditions “quick” and “healthy”, “meal B” is associated with context conditions “quick” and “side dish”, and “meal C” is associated with context conditions “slow”, “eating out”, and “healthy”. Here, when rating acceptor 104a accepts a rating indicating that user 5 has eaten “meal C”, estimator 104b estimates “slow”, “eating out”, and “healthy” as the actual priority status of user 5.

Comparer 104c compares the priority status (priority context conditions) estimated by estimator 104b with the priority status determined by priority status determiner 101. Then, comparer 104c determines whether a difference between the priority statuses is large or small. The magnitude of the difference is determined based on, for example, whether the priority status estimated by estimator 104b is similar to the priority status determined by priority status determiner 101.

As one example, if the priority status estimated by estimator 104b and the priority status determined by priority status determiner 101 match, or do not match but are similar, comparer 104c determines that the difference is small. On the other hand, if the priority status estimated by estimator 104b and the priority status determined by priority status determiner 101 do not match and are not similar, comparer 104c determines that the difference is large.

Trainer 104 determines whether to update (here, re-train) the process for determining the priority status by priority status determiner 101 (here, trained model 101a) based on the magnitude of the difference determined by comparer 104c. Specifically, if comparer 104c determines that the difference is small, the accuracy of the stated process can be considered to be relatively high, and thus trainer 104 does not update (re-train) the stated process (trained model 101a). On the other hand, if comparer 104c determines that the difference is large, the accuracy of the stated process can be considered to be relatively low, and thus trainer 104 updates (re-trains) the stated process (trained model 101a).

In the embodiment, trainer 104 re-trains trained model 101a through supervised learning using the priority status (priority context conditions) estimated by estimator 104b as correct answer data. Trainer 104 may execute the re-training of trained model 101a at the point in time when the comparison by comparer 104c is performed, or at the point in time when at least a predetermined amount of correct answer data has been accumulated.

As described in the foregoing reference example, storage 17 stores a variety of data. In particular, in addition to context data M1, food and drink data M2, and user data M3 (see FIG. 1), storage 17 stores (holds) the data for determining the meal recommendation and the like.

### (2) Operations

### (2.1) Presenting Meal Recommendation

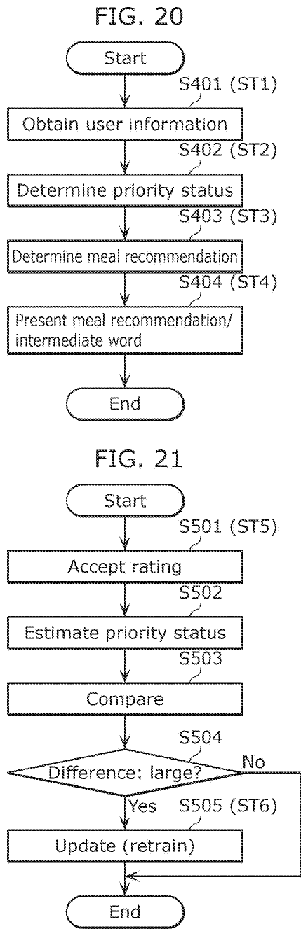

An example of operations by information presenting system 100a according to the foregoing embodiment will be described below with reference to FIG. 20. FIG. 20 is a flowchart illustrating an example of operations of information system 100a according to the embodiment. Specifically, FIG. 20 illustrates an example of operations in which information presenting system 100a receives a request from user 5 and makes a meal recommendation for user 5. The descriptions here will assume that the menu request signal has been transmitted from terminal device 2 in response to user 5 operating terminal device 2, and that communicator 10 of server 1b has received the menu request signal.

First, when the menu request signal is received, obtainer 19 obtains the user information (S401). Processing S401 corresponds to obtaining step ST1 of the information presenting method according to the embodiment. Next, priority status determiner 101 determines the priority status at the timing at which the menu request signal was received, based on the user information obtained by obtainer 19 (S402). Processing S402 corresponds to priority status determining step ST2 of the information presenting method according to the embodiment.

Next, meal recommendation determiner 102 determines a meal recommendation corresponding to the priority status determined by priority status determiner 101 (S403). In other words, meal recommendation determiner 102 determines meal information corresponding to the priority status determined by priority status determiner 101. Processing S403 corresponds to meal recommendation determining step ST3 of the information presenting method according to the embodiment. Presenter 103 then presents the meal recommendation determined by meal recommendation determiner 102 to user 5 (S404). In other words, presenter 103 generates a menu presentation signal that includes the meal recommendation determined by meal recommendation determiner 102, and transmits the generated menu presentation signal to terminal device 2 via communicator 10. Through this, the meal recommendation is made to user 5 through terminal device 2. Processing S404 corresponds to presenting step ST4 of the information presenting method according to the embodiment.

### (2.2) Updating Process for Determining Priority Status

Another example of operations by information presenting system 100a according to the foregoing embodiment will be described below with reference to FIG. 21. FIG. 21 is a flowchart illustrating another example of operations of information presenting system 100a according to the embodiment. Specifically, FIG. 21 illustrates an example of operations in which information presenting system 100a receives a rating for a meal recommendation from user 5, and updates the process for determining the priority status by priority status determiner 101 (re-trains trained model 101a). The descriptions here will assume that the rating signal has been transmitted from terminal device 2 in response to user 5 operating terminal device 2, and that communicator 10 of server 1b has received the rating signal.

First, rating acceptor 104a of trainer 104 accepts the rating included in the rating signal received by communicator 10 (S501). Processing S501 corresponds to rating accepting step ST5 of the information presenting method according to the embodiment. Next, estimator 104b of trainer 104 estimates the priority status based on the rating accepted by rating acceptor 104a (S502). Then, comparer 104c of trainer 104 compares the priority status estimated by estimator 104b with the priority status determined by priority status determiner 101 (S503).

If the result of the comparison indicates that the difference between the priority status estimated by estimator 104b and the priority status determined by priority status determiner 101 is small (S504: No), trainer 104 does not re-train trained model 101a. However, if the result of the comparison indicates that the difference between the priority status estimated by estimator 104b and the priority status determined by priority status determiner 101 is large (S504: Yes), trainer 104 updates (re-trains) trained model 101a (S505). Processing S505 corresponds to updating step ST6 of the information presenting method according to the embodiment. Here, trainer 104 executes the re-training of trained model 101a at the point in time when the comparison of the priority status is performed, but as has already been described, the re-training of trained model 101a may be performed at the point in time when at least a predetermined amount of correct answer data has been accumulated.

### (3) Effects, etc.

Advantages of information presenting system 100a according to the embodiment will be described next.

In the foregoing reference example and specific examples, a plurality of intermediate words B1 are presented to user 5, and the meal recommendation is made to user 5 for the first time in response to user 5 selecting at least one intermediate word B1. Accordingly, in the foregoing reference example and specific examples, it is necessary for user 5 to go through the process of selecting intermediate word B1 each time a meal recommendation is requested, which may feel troublesome to user 5.

As opposed to this, with information presenting system 100a according to the embodiment, the priority status estimated to be prioritized by user 5 is determined, and a meal recommendation based on the determined priority status is made to user 5, without going through the process of confirming the intentions of user 5. Accordingly, information presenting system 100a according to the embodiment has an advantage in that user 5 need not go through the process of selecting intermediate word B1 each time a meal recommendation is requested (i.e., the process of determining the intentions of user 5), which is less likely to feel troublesome to user 5.

Incidentally, although information presenting system 100a includes priority status determiner 101 and meal recommendation determiner 102 separately in the embodiment, the configuration is not limited thereto. For example, information presenting system 100a may include meal recommendation determiner 102 which incorporates these elements. In this case, meal recommendation determiner 102 executes the processing of priority status determiner 101. In other words, meal recommendation determiner 102 determines, based on the user information obtained by obtainer 19, a meal recommendation corresponding to a priority status determined to have a high priority level for user 5 from among a plurality of statuses related to user 5. In this case, the processing executed by priority status determiner 101 in the embodiment may be read as being executed by meal recommendation determiner 102 instead.

Similarly, although the information presenting method includes priority status determining step ST2 and meal recommendation determining step ST3 separately, the configuration is not limited thereto. For example, the information presenting method may include meal recommendation determining step ST3 which incorporates these steps. In this case, the processing of priority status determining step ST2 is executed in meal recommendation determining step ST3. In other words, in meal recommendation determining step ST3, based on the user information obtained in obtaining step ST1, a meal recommendation corresponding to a priority status determined to have a high priority level for user 5 is determined from among a plurality of statuses related to user 5. In this case, the processing pertaining to priority status determining step ST2 in the embodiment may be read as processing pertaining to meal recommendation determining step ST3.

### CONCLUSION

As described above, the information presenting method according to the embodiment includes the obtaining step (ST1), the meal recommendation determining step (ST3), the presenting step (ST4), and the rating accepting step (ST5). In the obtaining step (ST1), user information pertaining to a user (5) is obtained. In the meal recommendation determining step (ST3), based on the user information obtained in the obtaining step (ST1), a meal recommendation corresponding to a priority status determined to have a high priority level for the user (5) is determined from among a plurality of statuses related to the user (5). In the presenting step (ST4), the meal recommendation determined in the meal recommendation determining step (ST3) is presented to the user (5). In the rating accepting step (ST5), a rating by the user (5) of the meal recommendation presented in the presenting step (ST4) is accepted. The rating indicates whether the user (5) cooked a food in the meal recommendation or whether the user (5) ate the food.

This has an advantage in that there is no need to go through a process for determining the intentions of the user (5) each time they request a meal recommendation, which is less likely to feel troublesome to the user (5).

Additionally, for example, in the meal recommendation determining step (ST3) or the priority status determining step (ST2)), a status, among the plurality of statuses, having a priority rank that is at least a predetermined rank is determined as the priority status.

This has an advantage of making it easier to make a meal recommendation suited to the user (5).

Additionally, for example, in the presenting step (ST4), intermediate words (B1) corresponding to an attribute pertaining to the meal recommendation determined in the meal recommendation determining step (ST3) are further presented to the user (5).

This has an advantage in that having the user (5) confirm the intermediate words (B1) makes it easier for the user (5) to understand the basis of the meal recommendation.

Additionally, for example, in the presenting step (ST4), other intermediate words (B1) corresponding to an attribute pertaining to another meal recommendation different from the meal recommendation determined in the meal recommendation determining step (ST3) are further presented to the user (5).

This has an advantage in that when the user (5) has no intention of using the meal recommendation determined in the meal recommendation determining step (ST3), an additional meal recommendation can be made to the user (5), which makes it easy to improve the convenience to the user (5).

Additionally, for example, the information presenting method further includes the updating step (ST6). In the updating step (ST6), the process for determining the priority status is updated based on the rating accepted in the rating accepting step (ST5).

This has an advantage in that it is easier to improve the content of the meal recommendation for the user (5).

Additionally, for example, in the meal recommendation determining step (ST3) (or the priority status determining step (ST2)), the trained model (101a) trained through machine learning is used to determine the priority status from the user information.

This has an advantage in that a better improvement in the accuracy of determining the priority status can be expected than when determining the priority status through a rule-based method.

Additionally, for example, a program according to the embodiment causes at least one processor to execute the above-described information presenting method.

This has an advantage in that there is no need to go through a process for determining the intentions of the user (5) each time they request a meal recommendation, which is less likely to feel troublesome to the user (5).

Additionally, for example, the information presenting system (100a) according to the embodiment includes the obtainer (19), the meal recommendation determiner (102), the presenter (103), and the rating acceptor (104a). The obtainer (19) obtains user information pertaining to the user (5). The meal recommendation determiner (102) determines, based on the user information obtained by the obtainer (19), a meal recommendation corresponding to a priority status determined to have a high priority level for the user (5) from among a plurality of statuses related to the user (5). The presenter (103) then presents the meal recommendation determined by the meal recommendation determiner (102) to the user (5). The rating acceptor (104a) accepts a rating, by the user (5), of the meal recommendation presented by the presenter (103). The rating indicates whether the user (5) cooked a food in the meal recommendation or whether the user (5) ate the food.

This has an advantage in that there is no need to go through a process for determining the intentions of the user (5) each time they request a meal recommendation, which is less likely to feel troublesome to the user (5).

Additionally, for example, the terminal device (2) according to the embodiment includes the communicator (21) and the outputter (25). The communicator (21) communicates with the information presenting system (100a). The outputter (25) causes, when a signal including the meal recommendation is received from the presenter (103) by the communicator (21), the meal recommendation to be displayed in the display (25A).

1. An information presenting method comprising:
obtaining user information pertaining to a user;
determining, based on the user information obtained in the obtaining, a meal recommendation corresponding to a priority status determined to have a high priority level for the user from among a plurality of statuses related to the user;
presenting, to the user, the meal recommendation determined in the determining; and
accepting a rating made by the user for the meal recommendation presented in the presenting,
wherein the rating indicates whether the user cooked a food in the meal recommendation or whether the user ate the food.

2. The information presenting method according to claim 1,
wherein the determining includes determining, as the priority status, a status, among the plurality of statuses, having a priority rank that is at least a predetermined rank.

3. The information presenting method according to claim 1,
wherein the presenting further includes presenting, to the user, an intermediate word corresponding to an attribute pertaining to the meal recommendation determined in the determining.

4. The information presenting method according to claim 3,
wherein the presenting further includes presenting, to the user, another intermediate word corresponding to an attribute pertaining to another meal recommendation different from the meal recommendation determined in the determining.

5. The information presenting method according to claim 1, further comprising:
updating a process for determining the priority status, based on the rating accepted in the accepting.

6. The information presenting method according to claim 1,
wherein the determining includes determining the priority status using a trained model trained through machine learning to determine the priority status from the user information.

7. A non-transitory computer-readable recording medium having recorded thereon a program that causes at least one processor to execute the information presenting method according to claim 1.

8. An information presenting system comprising:
an obtainer that obtains user information pertaining to a user;
a meal recommendation determiner that determines, based on the user information obtained by the obtainer, a meal recommendation corresponding to a priority status determined to have a high priority level for the user from among a plurality of statuses related to the user;
a presenter that presents, to the user, the meal recommendation determined by the meal recommendation determiner; and
a rating acceptor that accepts a rating made by the user for the meal recommendation presented by the presenter,
wherein the rating indicates whether the user cooked a food in the meal recommendation or whether the user ate the food.

9. A terminal device comprising:
a communicator that communicates with the information presenting system according to claim 8; and
an outputter that, when a signal including the meal recommendation is received from the presenter by the communicator, causes the meal recommendation to be displayed in a display.
